(19) United States
(12) Patent Application Publication
(10) Pub. No.: US 2024/0260112 A1
(43) Pub. Date: Aug. 1, 2024

(54) METHOD PERFORMED BY RADIO TERMINAL AND RADIO TERMINAL

(71) Applicant: NEC CORPORATION, Minato-ku ,Tokyo (JP)

(72) Inventors: Kundan TIWARI, Tokyo (JP); Toshiyuki TAMURA, Tokyo (JP); Iskren IANEV, Tokyo (JP)

(73) Assignee: NEC CORPORATION, Minato-ku, Tokyo (JP)

(21) Appl. No.: 18/578,394

(22) PCT Filed: Jul. 12, 2022
(86) PCT No.: PCT/JP2022/027448

§ 371 Date: Jan. 11, 2024

(30) Foreign Application Priority Data
Jul. 16, 2021 (IN) 202111032116

(51) Int. Cl. H04W 76/18; H04W 48/18

(52) U.S. Cl. CPC H04W 76/18; H04W 48/18

(57) ABSTRACT

A method performed by a radio terminal includes receiving, from a core network, a reject message related to a first access type with information including maximum number of Protocol Data Unit (PDU) Session per network slice reached, and requesting a PDU session via a second access type.

### TECHNICAL FIELD

This present disclosure relates to a method performed by a radio terminal and a radio terminal.

### BACKGROUND ART

Network slicing feature was defined in the 3GPP release 15 and release 16 normative specifications. GSMA 5GJA has introduced in document NPL 6 the concept of Generic Slice Template (GST) from which several Network Slice Types descriptions can be derived. Some of these parameters in the GST point explicitly to the definition of parameters and bounds on the service delivered to the end customer. For instance, the GST aims at the limitation of the number of PDU sessions/PDN connections per network slice, or the number of devices supported per network slice, or the maximum UL or DL data rate per network slice. NPL 5 identified and addressed the gaps that needed to be filled in providing support for the GST parameters enforcement and the suitable solutions to address these gaps.

### CITATION LIST

### Non Patent Literature

[NPL 1] 3GPP TR 21.905: “Vocabulary for 3GPP Specifications”. V17.0.0 (2020-07)
[NPL 2] 3GPP TS 23.501: “System architecture for the 5G System (5GS)”. V17.1.1 (2021-06)
[NPL 3] 3GPP TS 23.502: “Procedures for the 5G System (5GS)”. V17.1.0 (2021-06)
[NPL 4] 3GPP TS 23.401: “General Packet Radio Service (GPRS) enhancements for Evolved Universal Terrestrial Radio Access Network (E-UTRAN) access”. V17.1.0 (2021-06)
[NPL 5] 3GPP TR 23.700-40: “Study on enhancement of network slicing”. V17.0.0 (2021-03)
[NPL 6] Generic Network Slice Template https://www.gsma.com/newsroom/wp-content/uploads/NG.116-v2.0.pdf
[NPL 7] 3GPP TS 23.503: “Policy and Charging Control Framework for the 5G System”. V17.1.0 (2021-06)
[NPL 8] 3GPP TS 24.501: “Non-Access-Stratum (NAS) protocol for 5G System (5GS); Stage 3”. V17.3.1 (2021-06)

### SUMMARY OF INVENTION

### Technical Problem

In case that the PDN connection establishment or the PDU session establishment fails due to Network slice admission control, the UE behavior is unclear in NPL 4, NPL 2 and NPL 3. For example, it is unclear whether or not the UE has to be backed-off till next attempt for the PDN connection establishment or the PDU session establishment.

### Solution to Problem

In an aspect of the present disclosure, a method performed by a radio terminal includes receiving, from a core network, a reject message related to a first access type with information including maximum number of Protocol Data Unit (PDU) Session per network slice reached, and requesting a PDU session via a second access type.

In an aspect of the present disclosure, a radio terminal includes means for receiving, from a core network, a reject message related to a first access type with information including maximum number of Protocol Data Unit (PDU) Session per network slice reached, and means for requesting a PDU session via a second access type.

### BRIEF DESCRIPTION OF DRAWINGS

FIG. 1 illustrates Network Slice Admission Control in EPS and 5GS.

FIG. 2 illustrates Network Slice Admission Control in EPS (Unsuccessful case).

FIG. 3 illustrates Back-off timer handling when the UE moves from 5GS to EPS.

FIG. 4 illustrates System overview.

FIG. 5 is a block diagram for a User equipment (UE).

FIG. 6 is a block diagram for a (R)AN node.

FIG. 7 illustrates System overview of (R)AN node based on O-RAN architecture.

FIG. 8 is a block diagram for a Radio Unit (RU).

FIG. 9 is a block diagram for a Distributed Unit (DU).

FIG. 10 is a block diagram for a Centralized Unit (CU).

FIG. 11 is a block diagram for an AMF.

FIG. 12 is a block diagram for an SMF.

FIG. 13 is a block diagram for a UPF.

FIG. 14 is a block diagram for a PCF.

FIG. 15 is a block diagram for an NEF.

FIG. 16 is a block diagram for a UDM.

FIG. 17 is a block diagram for an NWDAF.

FIG. 18 is a block diagram for an NSACF.

FIG. 19 illustrates Impacts to UE Requested PDN Connectivity Procedure.

### DESCRIPTION OF EMBODIMENTS

### Description of Disclosure with Aspects

This disclosure relates to a method of a core network apparatus, a method of a User Equipment, a method of a communication apparatus, a method of a first core network apparatus, a core network apparatus, and a User Equipment.

### Abbreviations

For the purposes of the present document, the abbreviations given in NPL 1 and the following apply. An abbreviation defined in the present document takes precedence over the definition of the same abbreviation, if any, in NPL 1.
4G-GUTI 4G Globally Unique Temporary UE Identity
5GC 5G Core Network
5GLAN 5G Local Area Network
5GS 5G System
5G-AN 5G Access Network
5G-AN PDB 5G Access Network Packet Delay Budget
5G-EIR 5G-Equipment Identity Register
5G-GUTI 5G Globally Unique Temporary Identifier
5G-BRG 5G Broadband Residential Gateway
5G-CRG 5G Cable Residential Gateway
5G GM 5G Grand Master
5G-RG 5G Residential Gateway
5G-S-TMSI 5G S-Temporary Mobile Subscription Identifier
5G VN 5G Virtual Network
5QI 5G QOS Identifier
AF Application Function
AMF Access and Mobility Management Function
APN Access Point Name
AS Access Stratum
ATSSS Access Traffic Steering, Switching, Splitting
ATSSS-LL ATSSS Low-Layer
AUSF Authentication Server Function
AUTN Authentication token
BMCA Best Master Clock Algorithm
BSF Binding Support Function
CAG Closed Access Group
CAPIF Common API Framework for 3GPP northbound APIs
CHF Charging Function
CN PDB Core Network Packet Delay Budget
CP Control Plane
DAPS Dual Active Protocol Stacks
DCN Dedicated Core Network
DL Downlink
DN Data Network
DNAI DN Access Identifier
DNN Data Network Name
DRX Discontinuous Reception
DS-TT Device-side TSN translator
ePDG evolved Packet Data Gateway
EBI EPS Bearer Identity
EPS Evolved Packet System
EUI Extended Unique Identifier
FAR Forwarding Action Rule
FN-BRG Fixed Network Broadband RG
FN-CRG Fixed Network Cable RG
FN-RG Fixed Network RG
FQDN Fully Qualified Domain Name
GFBR Guaranteed Flow Bit Rate
GMLC Gateway Mobile Location Centre
GPSI Generic Public Subscription Identifier
GUAMI Globally Unique AMF Identifier
GUTI Globally Unique Temporary UE Identity
HR Home Routed (roaming)
IAB Integrated access and backhaul
IMEI/TAC IMEI Type Allocation Code
IPUPS Inter PLMN UP Security
I-SMF Intermediate SMF
I-UPF Intermediate UPF
LADN Local Area Data Network
LBO Local Break Out (roaming)
LMF Location Management Function
LoA Level of Automation
LPP LTE Positioning Protocol
LRF Location Retrieval Function
MCC Mobile country code
MCX Mission Critical Service
MDBV Maximum Data Burst Volume
MFBR Maximum Flow Bit Rate
MICO Mobile Initiated Connection Only
MITM Man In The Middle
MME Mobility Management Entity
MNC Mobile Network Code
MPS Multimedia Priority Service
MPTCP Multi-Path TCP Protocol
N3IWF Non-3GPP Inter Working Function
N5CW Non-5G-Capable over WLAN
NAI Network Access Identifier
NEF Network Exposure Function
NF Network Function
NGAP Next Generation Application Protocol
NID Network identifier
NPN Non-Public Network
NR New Radio
NRF Network Repository Function
NSAC Network Slice Admission Control
NSACF Network Slice Admission Control Function
NSI ID Network Slice Instance Identifier
NSSAA Network Slice-Specific Authentication and
Authorization
NSSAAF Network Slice-Specific Authentication and
Authorization Function
NSSAI Network Slice Selection Assistance Information
NSSF Network Slice Selection Function
NSSP Network Slice Selection Policy
NSSRG Network Slice Simultaneous Registration Group
NW-TT Network-side TSN translator
NWDAF Network Data Analytics Function
PCF Policy Control Function
PDB Packet Delay Budget
PDN Packet Data Network
PDR Packet Detection Rule
PDU Protocol Data Unit
PEI Permanent Equipment Identifier
PER Packet Error Rate
PFD Packet Flow Description
PGW PDN Gateway
PLMN Public Land Mobile Network
PNI-NPN Public Network Integrated Non-Public Network
PPD Paging Policy Differentiation
PPF Paging Proceed Flag
PPI Paging Policy Indicator
PSA PDU Session Anchor
PTP Precision Time Protocol
QFI QOS Flow Identifier
QoE Quality of Experience
RACS Radio Capabilities Signalling optimisation
(R)AN (Radio) Access Network
RG Residential Gateway
RIM Remote Interference Management
RQA Reflective QoS Attribute
RQI Reflective QOS Indication
RSN Redundancy Sequence Number
SA NR Standalone New Radio
SBA Service Based Architecture
SBI Service Based Interface
SCP Service Communication Proxy
SD Slice Differentiator
SEAF Security Anchor Functionality
SEPP Security Edge Protection Proxy
SGW Serving Gateway
SMF Session Management Function
SMSF Short Message Service Function
SN Sequence Number
SN name Serving Network Name.
SNPN Stand-alone Non-Public Network
S-NSSAI Single Network Slice Selection Assistance Information
SSC Session and Service Continuity
SSCMSP Session and Service Continuity Mode Selection Policy
SST Slice/Service Type
SUCI Subscription Concealed Identifier
SUPI Subscription Permanent Identifier
SV Software Version
TAU Tracking Area Update
TMSI Temporary Mobile Subscriber Identity
TNAN Trusted Non-3GPP Access Network
TNAP Trusted Non-3GPP Access Point
TNGF Trusted Non-3GPP Gateway Function
TNL Transport Network Layer
TNLA Transport Network Layer Association
TSC Time Sensitive Communication
TSCAI TSC Assistance Information
TSN Time Sensitive Networking
TSN GM TSN Grand Master
TSP Traffic Steering Policy
TT TSN Translator
TWIF Trusted WLAN Interworking Function
UCMF UE radio Capability Management Function
UDM Unified Data Management
UDR Unified Data Repository
UDSF Unstructured Data Storage Function
UL Uplink
UL CL Uplink Classifier
UPF User Plane Function
URLLC Ultra Reliable Low Latency Communication
URRP-AMF UE Reachability Request Parameter for AMF
URSP UE Route Selection Policy
VID VLAN Identifier
VLAN Virtual Local Area Network
VPLMN Visited PLMN
W-5GAN Wireline 5G Access Network
W-5GBAN Wireline BBF Access Network
W-5GCAN Wireline 5G Cable Access Network
W-AGF Wireline Access Gateway Function

### Definitions

For the purposes of the present document, the terms and definitions given in NPL 1 and the following apply. A term defined in the present document takes precedence over the definition of the same term, if any, in NPL 1.

### General

Those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the Aspects of the present disclosure so as not to obscure the figures with details that will be readily apparent to those skilled in the art having the benefit of the description herein.

For the purpose of promoting an understanding of the principles of the disclosure, reference will now be made to the Aspect illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or entities or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an Aspect”, “in another Aspect” and similar language throughout this specification may, but not necessarily do, all refer to the same Aspect.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

As used herein, information is associated with data and knowledge, as data is meaningful information and represents the values attributed to parameters. Further knowledge signifies understanding of an abstract or concrete concept. Note that this example system is simplified to facilitate description of the disclosed subject matter and is not intended to limit the scope of this disclosure. Other devices, systems, and configurations may be used to implement the Aspects disclosed herein in addition to, or instead of, a system, and all such Aspects are contemplated as within the scope of the present disclosure.

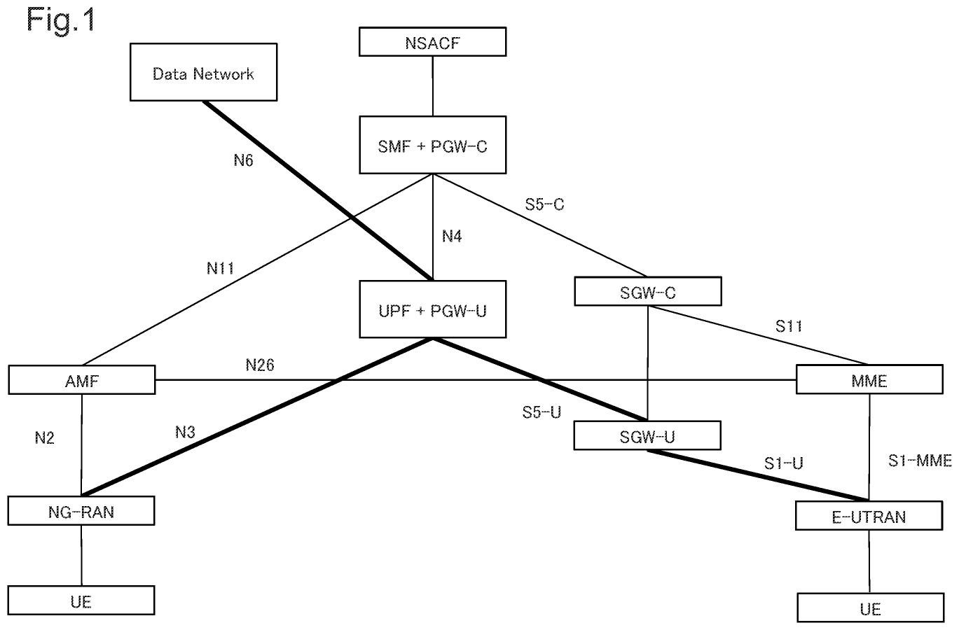

The FIG. 1 illustrates the architecture with respect to the Network Slice Admission Control in EPS and 5GS. The NSACF controls the network Slice Admission Control per network slice basis. When the UE is in the EPS, the SMF+PGW-C is responsible to interwork with the NSACF for updating the number of UEs allowed to use the network slice and the number of PDN connections allowed to establish that associates with the network slice.

In one example, the UDM in a supporting HPLMN may optionally keep a record of the PEIs or Type Allocation Codes values regarding UE ability to support NSAC feature. The UDM may, based on configuration or the optional PEI records, indicate the AMF that the UE supports NSAC feature. The UDM indicates whether the UE supports NSAC feature based on the PEI to an AMF in both HPLMN and VPLMN case.

In the Aspects, the Back off timer (BOT) for the UE is T3526 and back off timer (BOT) for the PDU session refers to the timer T3396 as defined in NPL 8 for the 5GS. In EPS the BOT for the UE and the BOT for the PDU session may be different than the T3526 or T3396.

Each of Aspects and elements included in the each Aspects described below may be implemented independently or in combination with any other. These Aspects include novel characteristics different from one another. Accordingly, these Aspects contribute to achieving objects or solving problems different from one another and contribute to obtaining advantages different from one another.

<Aspect 1: UE Maintains the Back-Off Timer when PDN Connection Establishment Fails Due to Network Slice Admission Control in EPS>

The Aspect 1 discloses a behavior of the UE in a case where the PDN connection establishment fails due to Network slice admission control in EPS.

There are two cases where the PDN connection establishment fails in the EPS. One case is that the number of UEs allowed to use a network slice reaches or exceeds the pre-defined limitation of the quota for the network slice. The pre-defined limitation of the quota for the network slice may be called as the maximum number of UEs allowed to use a network slice or threshold value for the number of UEs allowed to use a network slice.

Another case is that the number of PDN connections allowed to establish that associates with the network slice reaches or exceeds the pre-defined limitation of the quota for the network slice. The pre-defined limitation of the quota for the network slice may be called as the maximum number of PDN connections allowed to establish that associates with the network slice or threshold value for the number of PDU sessions allowed to establish that associates with the network slice.

This Aspect discloses that the SMF+PGW-C provides to the UE both, a back-off timer (BOT) for UE registration with a network slice and another BOT for PDN connection establishment associated with a network slice. The BOT for UE registration may be called as BOT for UE. The BOT for PDN connection establishment associated with a network slice may be called as BOT for PDU session.

The BOT for UE registration is referred by the UE to suppress (or to limit) next attempt for the PDN connection establishment to the same APN. The BOT for PDU session is referred by the UE to suppress next attempt for the PDN connection to the same APN. Similarly, the BOT for UE registration is referred by the UE to suppress next attempt for the ATTACH procedure or the TAU procedure with the PDN connection establishment to the same APN. The BOT for PDU session is referred by the UE to suppress next attempt for the ATTACH procedure or the TAU procedure with the PDN connection establishment to the same APN.

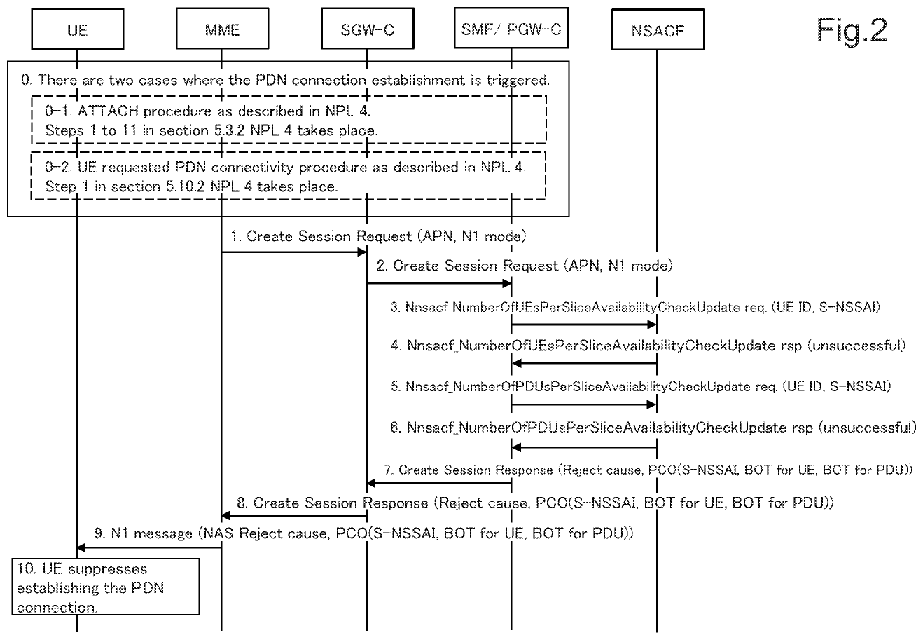

The FIG. 2 illustrates the failure of the ATTACH procedure or the PDN connection establishment procedure due to Network Slice Admission Control in EPS.

0. The UE initiates either the ATTACH procedure (step 0-1) or the UE requested PDN connectivity procedure (step 0-2). During the procedure, a NAS message sent by the UE during the procedure may include the UE capability information. The UE capability information may be “N1 mode supported” in the UE network capability parameter. The UE capability information may be “N1 mode not supported” in the UE network capability parameter. If “N1 mode supported” is indicated, the UE can register to the 5GS. Another UE capability information may indicate whether the UE is capable to handle the Network Slice Admission Control related procedure. For example, it indicates whether the UE can receive and handle the Network Slice Admission Control (NSAC) related parameters or can handle NSAC procedures for the EPS. For example, during the procedure, the UE may send, to the MME, the UE capability information. The MME sends the another parameter indicating whether the UE supports NSAC procedure in the create session request message to the S-GW which sends it in the create session request message to the SMF+PGW-C. The SMF+PGW-C will execute NSAC procedure if the another capability information indicates NSAC is supported. If the another capability indicates NSAC is not supported or the another capability is not received then the PGW-C+SMF determines that the UE doesn't support NSAC feature and it does not executes NSAC procedure. In one example the PGW-C+SMF executes the number of PDU session check and update procedure or number of UE check and update procedure towards the NSAC as defined in below but on failure of the NSAC procedure the SMF+PGW-C rejects the PDN connection establishment, but does not send the BOT for the UE or BOT for the PDU.

1. The MME selects the SGW-C and PGW-C. Then, the MME sends, to the SGW-C, the Create Session Request message including the APN and N1 mode parameter. The N1 mode parameter is included if the MME receives “N1 mode supported” in the UE network capability parameter in step 0. The N1 mode parameter may indicate that the UE is capable to handle the Network Slice Admission Control related procedure or the UE can receive and handle the Network Slice Admission Control related parameters or procedures for the EPS. For example, during the ATTACH procedure or the UE requested PDN connectivity procedure, the MME selects the SGW-C and the PGW-C, and sends the Create Session Request message to the SGW-C. The Create Session Request message may be sent during the ATTACH procedure or the UE requested PDN connectivity procedure. For example, the APN may be related to the ATTACH procedure or the UE requested PDN connectivity procedure. The APN may be called as information indicating the APN or information related to the APN.

2. The SGW-C sends, to the SMF/PGW-C, the Create Session Request message including the APN and the N1 mode parameter. For example, the SGW-C sends the Create Session Request message to the SMF/PGW-C in a case where the SGW-C receives the Create Session Request message from the MME.

3. The SMF/PGW-C finds an associated S-NSSAI to the received APN based on the received APN and local configuration. The SMF/PGW-C may be called as SMF+PGW-C. For example, the SMF/PGW-C finds an associated S-NSSAI to the received APN in a case where the SMF/PGW-C receives the Create Session Request message from the SGW-C. Then the SMF/PGW-C sends a message e.g. Nnsacf_NumberOfUEsPerSliceAvailabilityCheckUpdate request to the NSACF. For example the SMF/PGW-C sends the Nnsacf_NumberOfUEsPerSliceAvailabilityCheckUpdate request to check if the attachment or registration of the UE is allowed.

For example, in a case where N1 mode is indicated in the Create Session Request message in step 2 (e.g. in a case where the SMF/PGW-C determines that the N1 mode parameter is included in the received Create Session Request message in step 2), the SMF/PGW-C sends the Nnsacf_NumberOfUEsPerSliceAvailabilityCheckUpdate request to the NSACF. The Nnsacf_NumberOfUEsPerSliceAvailabilityCheckUpdate request may include UE ID (identity or identifier for the UE) and the S-NSSAI associated to the received APN. For example, the SMF/PGW-C stores mapping information of S-NSSAIs and APNs, hence the SMF/PGW-C can determine the associated S-NSSAI to the received APN based on the received APN from the SGW-C.

In a case where N1 mode is not indicated in the Create Session Request message in step 2 (e.g. in a case where the SMF/PGW-C determines that the N1 mode parameter is not included in the received Create Session Request message in step 2), the SMF/PGW-C may not interwork with the NSACF and proceed with step 7.

Note that, as the network slice is the 5GS feature, the Network Slice Admission Control may not be needed as far as the UE never accesses to the 5GS.

The Nnsacf_NumberOfUEsPerSliceAvailabilityCheckUpdate request may be called as an Nnsacf_NumberOfUEsPerSliceAvailabilityCheckUpdate request message.

4. The NSACF sends, to the SMF/PGW-C, a response message e.g. Nnsacf_NumberOfUEsPerSliceAvailabilityCheckUpdate response indicating that the UE is not allowed to use the S-NSSAI due to limitation of the quota, i.e. the maximum number of UEs has been reached or the number of the UEs registered with the network slice has exceeded the limitation of UE quota of the S-NSSAI. For example, the network slice is related to the S-NSSAI.

For example, if the maximum number of UEs has been reached or the number of the UEs registered with the network slice related to the received S-NSSAI has exceeded the limitation of UE quota of the S-NSSAI, the NSACF sends, to the SMF/PGW-C, the Nnsacf_NumberOfUEsPerSliceAvailabilityCheckUpdate response indicating that the UE is not allowed to use the S-NSSAI due to limitation of the quota.

The Nnsacf_NumberOfUEsPerSliceAvailabilityCheckUpdate response may include information indicating that the UE is not allowed to use the S-NSSAI due to limitation of the quota, or the maximum number of UEs has been reached or the number of the UEs registered with the network slice related to the S-NSSAI has exceeded the limitation of UE quota of the S-NSSAI.

The Nnsacf_NumberOfUEsPerSliceAvailabilityCheckUpdate response may be called as an Nnsacf_NumberOfUEsPerSliceAvailabilityCheckUpdate response message.

5. The PGW-C sends a message e.g. SMF/Nnsacf_NumberOfPDUsPerSliceAvailabilityCheckUpdate request to the NSACF to check if the quota is available to create a PDN connection for the S-NSSAI (or to check if the creating the PDN connection is allowed). The Nnsacf_NumberOfPDUsPerSliceAvailabilityCheckUpdate request may include the UE ID and the S-NSSAI associated to the received APN.

The Nnsacf_NumberOfPDUsPerSliceAvailabilityCheckUpdate request may be called as an Nnsacf_NumberOfPDUsPerSliceAvailabilityCheckUpdate request message.

For example, in a case where N1 mode is indicated in the Create Session Request message in step 2 (e.g. in a case where the SMF/PGW-C determines that the N1 mode parameter is included in the received Create Session Request message in step 2), the SMF/PGW-C may send the Nnsacf_NumberOfPDUsPerSliceAvailabilityCheckUpdate request to the NSACF.

For example, in a case where the SMF/PGW-C sends the Nnsacf_NumberOfUEsPerSliceAvailabilityCheckUpdate request to the NSACF, the SMF/PGW-C may send the Nnsacf_NumberOfPDUsPerSliceAvailabilityCheckUpdate request to the NSACF.

For example, in a case where the SMF/PGW-C receives the Nnsacf_NumberOfUEsPerSliceAvailabilityCheckUpdate response from the NSACF, the SMF/PGW-C may send the Nnsacf_NumberOfPDUsPerSliceAvailabilityCheckUpdate request to the NSACF.

6. The NSACF sends, to the SMF/PGW-C, a response message e.g. Nnsacf_NumberOfPDUsPerSliceAvailabilityCheckUpdate response indicating that the PDN connection is not allowed to establish due to limitation of the quota, i.e. the maximum number of PDN connections has been reached or the number of the PDN connections has exceeded the limitation of PDN connection quota of the APN associated with the S-NSSAI.

The Nnsacf_NumberOfPDUsPerSliceAvailabilityCheckUpdate response may be called as an Nnsacf_NumberOfPDUsPerSliceAvailabilityCheckUpdate response message.

For example, if the maximum number of PDN connections has been reached or the number of the PDN connections has exceeded the limitation of PDN connection quota, the NSACF sends, to the SMF/PGW-C, the Nnsacf_NumberOfPDUsPerSliceAvailabilityCheckUpdate response indicating that the PDN connection is not allowed to establish due to limitation of the quota.

The Nnsacf_NumberOfPDUsPerSliceAvailabilityCheckUpdate response may include information indicating that the UE is not allowed to use the S-NSSAI due to limitation of the quota, or the maximum number of PDN connections has been reached or the number of the PDN connections has exceeded the limitation of PDN connection quota.

For example, the NSACF may store mapping information of S-NSSAIs and APNs. In this case, if the NSACF receives the S-NSSAI from the SMF/PGW-C in step 5, and determines, based on the received S-NSSAI, that the PDU session for the S-NSSAI is not allowed to establish due to limitation of the quota, i.e. the maximum number of PDU sessions for the S-NSSAI has been reached or the number of the PDU sessions for the S-NSSAI has exceeded the limitation of PDU session quota of the S-NSSAI, the NSACF may determine, based on the mapping information, that the PDN connection for the APN associated with the S-NSSAI is not allowed to establish due to limitation of the quota, i.e. the maximum number of PDN connections for the APN associated with the S-NSSAI has been reached or the number of the PDN connections for the APN related to the S-NSSAI has exceeded the limitation of PDN connection quota of the APN. Then the NSACF may send the Nnsacf_NumberOfPDUsPerSliceAvailabilityCheckUpdate response indicating that the PDN connection is not allowed to establish due to limitation of the quota.

For example, if the NSACF receives the S-NSSAI from the SMF/PGW-C in step 5, and determines, based on the received S-NSSAI, that the PDU session for the S-NSSAI is not allowed to establish due to limitation of the quota, i.e. the maximum number of PDU sessions for the S-NSSAI has been reached or the number of the PDU sessions for the S-NSSAI has exceeded the limitation of PDU session quota of the S-NSSAI, the NSACF may send the Nnsacf_NumberOfPDUsPerSliceAvailabilityCheckUpdate response indicating that the PDU session for the S-NSSAI is not allowed to establish due to limitation of the quota, i.e. the maximum number of PDU sessions for the S-NSSAI has been reached or the number of the PDU sessions for the S-NSSAI has exceeded the limitation of PDU session quota of the S-NSSAI. In this case, the SMF/PGW-C receives the Nnsacf_NumberOfPDUsPerSliceAvailabilityCheckUpdate response, and may determine, based on the mapping information stored in the SMF/PGW-C, that the PDN connection for the APN associated with the S-NSSAI is not allowed to establish due to limitation of the quota, i.e. the maximum number of PDN connections for the APN associated with the S-NSSAI has been reached or the number of the PDN connections for the APN related to the S-NSSAI has exceeded the limitation of PDN connection quota of the APN.

7. The SMF/PGW-C sends, to the SGW-C, the Create Session Response message including new reject cause and a PCO (Protocol Configuration Option) parameter.

The new reject cause may have a value “Unsuccessful PDN connection establishment due to Quota control”, “Unsuccessful PDN connection establishment due to UE Quota control”, “Unsuccessful PDN connection establishment due to PDN connection Quota control” or any other notation for a reject cause with the purpose to reject the PDN connection establishment due to the number of the PDN connections associated with the network slice has reached or exceeded the maximum quota.

The new reject cause may have any other notation for a reject cause with the purpose to reject the PDN connection establishment due to the number of the UEs registered with the network slice has reached or exceeded the maximum quota.

The new reject cause may have a value “maximum number of UEs per network slice reached” or “maximum number of PDU Sessions per network slice reached”.

The PCO parameter includes S-NSSAI, the BOT for UE and the BOT for PDU session. The S-NSSAI is information indicating the network slice associated with the APN. The BOT for UE may be related to the S-NSSAI. The BOT for PDU session may be related to the S-NSSAI. As mentioned above, the S-NSSAI is related to or associated to the received APN in step 2, hence the BOT for UE may be related to the APN and the BOT for PDU session may be related to the APN. The BOT in this disclosure may means that a value or a period of the BOT. The PCO parameter may be called as PCO. The BOT for PDU session may be called as BOT for PDU.

For example, the SMF/PGW-C sends, to the SGW-C, the Create Session Response message including the new reject cause and the PCO parameter in a case where the SMF/PGW-C receives, from the NSACF, at least one of the Nnsacf_NumberOfUEsPerSliceAvailabilityCheckUpdate response and the Nnsacf_NumberOfPDUsPerSliceAvailabilityCheckUpdate response.

For example, the SMF/PGW-C sends, to the SGW-C, the Create Session Response message including the new reject cause and the PCO parameter in a case where the SMF/PGW-C receives, from the NSACF, the Nnsacf_NumberOfUEsPerSliceAvailabilityCheckUpdate response including information indicating that the UE is not allowed to use the S-NSSAI due to limitation of the quota, or the maximum number of UEs has been reached or the number of the UEs registered with the network slice has exceeded the limitation of UE quota of the S-NSSAI. In this case, the new reject cause included in the Create Session Response message may have a value “Unsuccessful PDN connection establishment due to Quota control”, “Unsuccessful PDN connection establishment due to UE Quota control”, “maximum number of UEs per network slice reached” or any other notation for a reject cause with the purpose to reject the PDN connection establishment due to the number of the UEs registered with the network slice has reached or exceeded the maximum quota.

For example, the SMF/PGW-C sends, to the SGW-C, the Create Session Response message including the new reject cause and the PCO parameter in a case where the SMF/PGW-C receives, from the NSACF, the Nnsacf_NumberOfPDUsPerSliceAvailabilityCheckUpdate response including information indicating that the UE is not allowed to use the S-NSSAI due to limitation of the quota, or the maximum number of PDN connections has been reached or the number of the PDN connections has exceeded the limitation of PDN connection quota of the APN. In this case, the new reject cause included in the Create Session Response message may have a value “Unsuccessful PDN connection establishment due to Quota control”, “Unsuccessful PDN connection establishment due to PDN connection Quota control”, “maximum number of PDU Sessions per network slice reached” or any other notation for a reject cause with the purpose to reject the PDN connection establishment due to the number of the PDN connections associated with the network slice has reached or exceeded the maximum quota.

8. The SGW-C sends, to the MME, the Create Session Response message including the new reject cause and the PCO parameter as included by the SMF/PGW-C in step 7. For example, the PCO parameter includes the S-NSSAI, BOT for UE, and BOT for PDU.

For example, the SGW-C sends the Create Session Response message in a case where the SGW-C receives the Create Session Response message of the step 7 from the SMF/PGW-C.

9. The MME sends, to the UE, the NAS message including a new NAS reject cause and the PCO parameter. For example, the PCO parameter includes S-NSSAI, BOT for UE, and BOT for PDU. The MME creates the new NAS reject cause based on the reject cause value that is received in step 8 from the SGW-C. The NAS reject cause may have same or corresponding value to the reject cause value that is received in step 8 from the SGW-C. The NAS message may be called as a N1 message.

The new NAS reject cause may have a value “Unsuccessful PDN connection establishment due to Quota control”, “Unsuccessful PDN connection establishment due to UE Quota control”, “Unsuccessful PDN connection establishment due to PDN connection Quota control”, “maximum number of UEs per network slice reached” or “maximum number of PDU Sessions per network slice reached”.

The new NAS reject cause may have any other notation for a reject cause with the purpose to reject the PDN connection establishment due to the number of the PDN connections associated with the network slice has reached or exceeded the maximum quota.

The new NAS reject cause may have any other notation for a reject cause with the purpose to reject the PDN connection establishment due to the number of the UEs registered with the network slice has reached or exceeded the maximum quota.

If the MME considers the UE as neither capable to interwork with 5GS nor capable to handle Network Slice Admission Control based on information received in step 0, the MME may send, to the UE, another NAS message indicating unsuccessful PDN connection establishment by using an existing message and an existing cause value.

10. Upon reception of the NAS message in step 9, the UE starts the BOT for UE and the BOT for PDU session, and the UE may take following actions:
The UE associates the APN that was sent to the MME in step 0 and the received S-NSSAI in the PCO at step 9. The APN may be called as an associated APN.
The UE applies both BOTs to suppress PDN connection establishment to the associated APN in EPS as far as the UE stays on the same PLMN or ePLMN (Equivalent PLMN). Both, the BOT for UE and the BOT for PDU Session shall not reset or stop with the cell change, TA change, RAT change or registration area change within the PLMN or ePLMN.

For example, the UE does not initiate PDN connection establishment to the associated APN in EPS in a case where at least one of the BOTs is running.

For example, the UE may initiate PDN connection establishment to the associated APN in EPS in a case where at least one of the BOTs expires.

For example, the UE does not initiate PDN connection establishment to the associated APN in EPS in a case where the BOT for PDU Session is running.

For example, the UE may initiate PDN connection establishment to the associated APN in EPS in a case where the BOT for PDU Session expires.

For example, the UE does not initiate the ATTACH procedure or the TAU procedure with the PDN connection establishment to the associated APN in a case where the BOT for UE is running.

For example, the UE may initiate the ATTACH procedure or the TAU procedure with the PDN connection establishment to the associated APN in a case where the BOT for UE expires.
If the BOT for UE and the BOT for PDU session have different values, then the UE applies the BOT with the longer value for suppressing to PDN connection establishment. The UE may apply the BOT with the shorter value for suppressing to PDN connection establishment.
When the UE moves to different PLMN in EPS, the UE clears both BOTs. For example, the clearing both BOTs may mean that the UE does not consider both BOTs.
When the UE moves from EPS to 5GS where the PLMN is different, the UE clears both BOTs.

The moving from EPS to 5GS may mean inter-system change or inter-system handover from EPS to 5GS.
When the UE moves from EPS to 5GS within the same PLMN or ePLMN, the UE clears both BOTs.
When the UE moves from EPS to 5GS within the same PLMN or ePLMN, the UE maintains both BOTs. When the UE initiates the Registration procedure in the 5GS as described in NPL 3, the UE refers to the BOT for UE when the UE constructs the Requested NSSAI to include in the Registration Request message. I.E., if the BOT for UE is still running for the S-NSSAI that was received at step 9, the UE shall not include that S-NSSAI to the Requested NSSAI parameter.

When the UE moves from EPS to 5GS within the same PLMN or ePLMN, the UE maintains both BOTs. When the BOT for UE expires for the S-NSSAI, the UE may initiate a Registration procedure by sending the Registration request message and include the S-NSSAI for which the BOT for UE has expired in the Requested NSSAI parameter of the Registration request message.
When the UE moves from EPS to 5GS within the same PLMN or ePLMN, the UE maintains both BOTs. The UE shall not initiate the UE Requested PDU Session Establishment in the 5GS as described in NPL 3 if the BOT for PDU session that was received at step 9 is still running for the S-NSSAI.
When the UE moves from EPS to 5GS within the same PLMN or ePLMN, the UE maintains both BOTs. When the BOT for PDU session expires for the S-NSSAI, the UE may initiate a UE Requested PDU Session Establishment in the 5GS as described in NPL 3 with the S-NSSAI.
When the UE changes from “N1 mode supported” to “N1 mode not supported” in the UE capability information and following the ATTACH procedure or the TAU procedure is successfully completed, the UE clears both BOTs if at least one of the BOTs is running. The “N1 mode not supported” may mean that the UE cannot register to the 5GS or the UE cannot receive and handle the Network Slice Admission Control related parameters or procedures for the EPS.
When the UE changes from “N1 mode supported” to “N1 mode not supported” in the UE capability information and following the ATTACH procedure or the TAU procedure is successfully completed, the UE does not clear both BOTs if at least one of the BOTs is running. I,e, the UE keeps the BOTs running.

### <Variant 1 of the Aspect 1>

In step 1, the MME selects a PGW-C taking the “N1 mode supported” in the UE network capability parameter into account. Unless the “N1 mode supported” is indicated by the UE, the MME selects, for example by the DNS query to a DNS server, a PGW-C that does not provide the interworking function with the 5GS. I.e. As the chosen PGW-C is a standalone and does not have any co-located SMF functionalities, there is no interface to the NSACF. With this approach, the Network Slice Admission Control does not restrict the PDN connection establishment procedure as far as there is no chance for the UE to access to the 5GS.

### <Variant 2 of the Aspect 1>

In steps 7, 8 and 9, the PCO may include one BOT. This BOT is considered by the UE when the UE establishes a PDN connection to the APN that is associated with the S-NSSAI.

For example, the UE does not initiate a PDN connection establishment to the APN that is associated with the S-NSSAI in a case where the one BOT is running.

For example, the UE may initiate a PDN connection establishment to the APN that is associated with the S-NSSAI in a case where the one BOT expires.

For example, the UE does not initiate the ATTACH procedure or the TAU procedure with the PDN connection establishment to the APN in a case where the one BOT is running.

For example, the UE may initiate the ATTACH procedure or the TAU procedure with the PDN connection establishment to the APN in a case where the one BOT expires.

If there is one common BOT received, the UE applies this BOT to suppress both, the Registration procedure with the S-NSSAI and the UE Requested PDU Session Establishment procedure with the S-NSSAI when the UE moves from EPS to 5GS. The S-NSSAI is associated with the APN.

For example, after the UE moves from EPS to 5GS, the UE does not initiate the Registration procedure with the S-NSSAI in a case where the one BOT is running.

For example, after the UE moves from EPS to 5GS, the UE may initiate the Registration procedure with the S-NSSAI in a case where the one BOT expires.

For example, after the UE moves from EPS to 5GS, the UE does not initiate the UE Requested PDU Session Establishment procedure with the S-NSSAI in a case where the one BOT is running.

For example, after the UE moves from EPS to 5GS, the UE may initiate the UE Requested PDU Session Establishment procedure with the S-NSSAI in a case where the one BOT expires.

### <Variant 3 of the Aspect 1>

The UE behavior described in steps 10 is also applicable when the BOT for UE and the BOT for PDU session are received from the 5GS by the UE, i.e. from the AMF or SMF respectively. For example, the AMF may receive, from SMF/PGW-C, a message including the Reject cause and the PCO as mentioned in step 7, and the AMF may send the Reject cause and the PCO to the UE. Then the UE may perform the process mentioned in step 10. When the AMF receives Nnsacf_NumberOfUEsPerSliceAvailabilityCheckAndUpdate response message containing S-NSSAI and reject cause indicating that the maximum number of UEs reached, the AMF sends the S-NSSAI and the BOT for UE for the S-NSSAI to the UE in Registration Accept, Registration Reject, Deregistration Request message or the configuration update command message. The SMF sends the BOT for PDU session to the UE in PDU session establishment reject message when the SMF receives Nnsacf_NumberOfPDUsPerSliceAvailabilityCheckAndUpdate response message indicating number of PDU sessions reached to the maximum threshold for the network slice.

### <Variant 4 of the Aspect 1>

The MME behavior as described in step 9 toward the UE is also applicable to the AMF. I.e., if the AMF knows that the UE is not capable to handle Network Slice Admission Control based on information received in step 0, the AMF may send, to the UE, another NAS message (e.g. existing 5GSM message or a new 5GSM message) indicating unsuccessful PDU session establishment using an existing message and an existing cause value. The AMF may receive, from the MME, the information indicating that the UE is not capable to handle Network Slice Admission Control.

### <Variant 5 of the Aspect 1>

There can be a scenario when either the number of registered UEs exceeds the number of UEs quota (or the maximum number of the registered UEs) or the number of PDU sessions exceeds the number of PDU sessions quota (or the maximum number of the PDU sessions). In this case, in step 7 the SMF/PGW-C sends the Create Session Response message containing the single reject cause Information Element (IE) which is set to “maximum number of UEs per network slice reached” when the number of UEs registered to the S-NSSAI reaches or exceeds the quota, or “maximum number of PDU Sessions per network slice reached” when the number of PDU sessions for the S-NSSAI reaches or exceeds the quota. The SMF/PGW-C, in addition to the reject cause, may include a BOT for UE when the number of UEs registered to the S-NSSAI reaches or exceeds the quota, or a BOT for PDU session when the number of PDU sessions for the S-NSSAI reaches or exceeds the quota. In step 8, when the MME receives the reject cause and optionally BOT, the MME sends the reject cause and optionally the BOT in the NAS message (e.g. PDN connectivity Reject message). When the UE receives the NAS message with reject cause and the BOT, the UE shall not initiate PDN Connectivity Request for the APN during the procedure related to PDN connection Request for the period of the BOT. In addition, when the UE moves from EPS to 5GS, the UE shall not send the S-NSSAI in the Requested NSSAI when reject cause is set to “maximum number of UEs per network slice reached”, while the BOT for UE is running or the UE shall not initiate PDU session establishment procedure when the UE received the reject cause set to “maximum number of PDU Sessions per network slice reached” while the BOT for PDU session is running.

In one example, when the MME receives the reject cause set to either “maximum number of UEs per network slice reached” or “maximum number of PDU Sessions per network slice reached”, the MME maps this cause value to ESM cause value #26 “insufficient resources” and T3396 timer set to the BOT.

### <Variant 6 of the Aspect 1>

In one example, the NSCAF or P-GW/SMF node (or SMF/PGW-C) sends, to the UE, an information element indicating whether the reject cause value (e.g. “maximum number of UEs per network slice reached” or “maximum number of PDU Sessions per network slice reached”) and BOT (optional) are applicable to 5GS or not (“not” means that the reject cause and the BOT are only applicable to the EPS).

For example, this information element may be included in the message in at least one of steps 4, 6, 7, 8 and 9.

When the UE receives the information element which indicates the reject cause value “maximum number of UEs per network slice reached” or “maximum number of PDU Sessions per network slice reached” is applicable to the 5GS (for example, the UE receives the information element which indicates the NAS reject cause which is set to “maximum number of UEs per network slice reached” or “maximum number of PDU Sessions per network slice reached” is applicable to the 5GS), the UE shall not send the S-NSSAI in the Requested NSSAI when the UE receives the reject cause value (for example, the NAS reject cause) which is set to “maximum number of UEs per network slice reached”, while the BOT for UE is running, or the UE shall not initiate PDU session establishment procedure when the UE receives the reject cause value (for example, the NAS reject cause) which is set to “maximum number of PDU Sessions per network slice reached”, while the BOT for PDU session is running. Otherwise (e.g. if the information element indicates the reject cause value “maximum number of UEs per network slice reached” or “maximum number of PDU Sessions per network slice reached” is not applicable to the 5GS) the UE may include the S-NSSAI in the Requested NSSAI or initiate PDU session establishment procedure for the S-NSSAI. In one example the UE shall keep the BOT running and when the UE moves back to 5GS then the UE keeps the BOT running.

In one example the NSCAF or the SMF/PGW-C may send, to the UE, another information element indicating whether the reject cause (e.g. “maximum number of UEs per network slice reached” or “maximum number of PDU Sessions per network slice reached”) and BOT (optional) are applicable to a PLMN other than the registered PLMN or the ePLMN of the registered PLMN or not. If the IE indicates that the reject cause is applicable to the PLMN other than registered PLMN or its ePLMN then on selecting the PLMN other than registered PLMN or its ePLMN, the UE shall not initiate any PDN connection establishment procedure to the APN if the reject cause is set to “maximum number of PDU Sessions per network slice reached”, while the BOT for UE is running, or shall not send Registration Request message with Requested NSSAI containing the S-NSSAI if the reject cause is set to “maximum number of UEs per network slice reached”, while the BOT for PDU session is running. Otherwise (e.g. if the IE indicates that the reject cause is not applicable to the PLMN other than registered PLMN or its ePLMN) the UE may initiate any PDN connection establishment procedure to the APN or the PDU session establishment procedure related to the S-NSSAI if the reject cause is set to “maximum number of PDU Sessions per network slice reached” or may send Registration Request message with Requested NSSAI containing the S-NSSAI if the reject cause is set to “maximum number of UEs per network slice reached”.

### <Variant 7 of the Aspect 1>

In one example when the SMF/PGW-C sends, to the NSACF, the Nnsacf_NumberOfUEsPerSliceAvailabilityCheckUpdate request including an IE indicating that the Nnsacf_NumberOfUEsPerSliceAvailabilityCheckUpdate request is sent from EPS or the Nnsacf_NumberOfPDUsPerSliceAvailabilityCheckUpdate request containing an IE indicating that the Nnsacf_NumberOfPDUsPerSliceAvailabilityCheckUpdate request is sent from EPS, or a new message to apply NSAC procedure containing an IE indicating that the message is sent from the EPS, on determining that the message is from EPS, the NSCAF may perform NSAC procedure related to the number of the PDU sessions for the S-NSSAI and the number of UEs per S-NSSAI and return results as specified in the Aspect 1 to the SMF/PGW-C. Then the SMF/PGW-C follows step 7.

For example, the IE indicating that the Nnsacf_NumberOfUEsPerSliceAvailabilityCheckUpdate request is sent from EPS may be called as an IE indicating that the Nnsacf_NumberOfUEsPerSliceAvailabilityCheckUpdate request is triggered by EPS.

For example, the IE indicating that the Nnsacf_NumberOfPDUsPerSliceAvailabilityCheckUpdate request is sent from EPS may be called as an IE indicating that the Nnsacf_NumberOfPDUsPerSliceAvailabilityCheckUpdate request is triggered by EPS.

For example, the IE indicating that the message is sent from the EPS may be called as an IE indicating that the message is triggered by EPS.

For example, the Aspect 1 and Variants of the Aspect 1 can solve the problem that the UE behavior is unclear in case that the PDN connection establishment or the PDU session establishment fails due to Network slice admission control

For example, the Aspect 1 and Variants of the Aspect 1 can solve the problem that it is unclear whether or not the UE has to be backed-off till next attempt for the PDN connection establishment or the PDU session establishment.

<Aspect 2: UE Maintains the Back-Off Timer when the UE Moves from 5GS to EPS>

The Aspect 2 discloses a behavior of the UE in a case where the PDU session establishment fails due to Network slice admission control in 5GS.

There are two cases where the PDU session establishment fails in the 5GS. One case is that the number of UEs allowed to use the network slice reaches or exceeds the pre-defined limitation of the quota for the network slice. Another case is that the number of PDU sessions allowed to establish that associates with the network slice reaches or exceeds the pre-defined limitation of the quota for the network slice.

This Aspect discloses the UE behavior when a slice registration fails due to the PDU session establishment failure for the S-NSSAI and the UE selects EPS network.

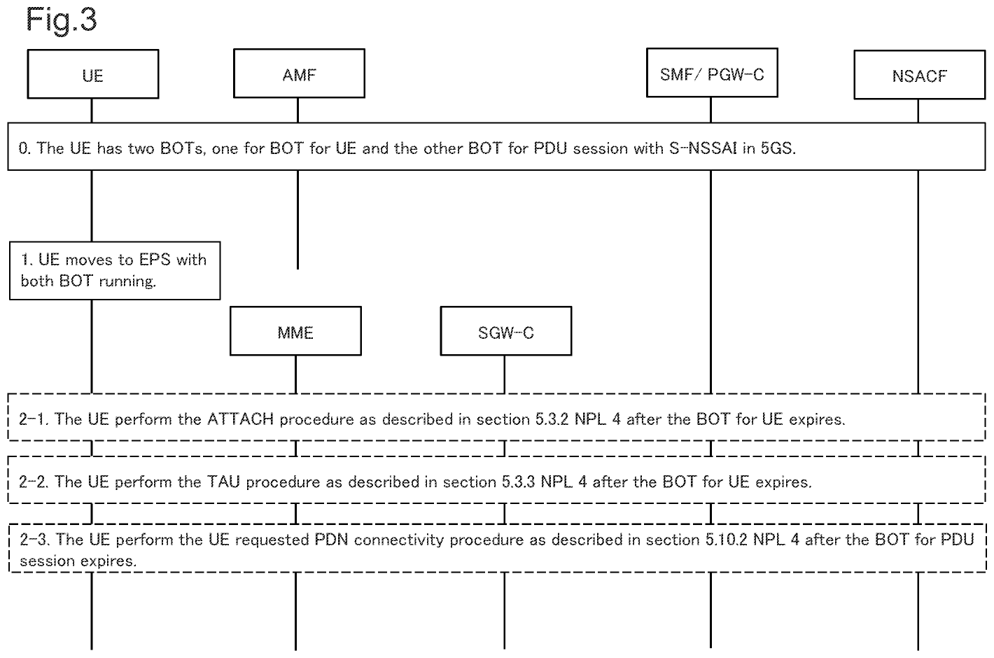

The FIG. 3 illustrates procedure for Back-off timer handling when the UE moves from 5GS to EPS

0. The UE has two BOTs, one is a BOT for UE and another one is a BOT for PDU session in 5GS.

For example, the AMF sends, to the NSACF, Nnsacf_NumberOfUEsPerSliceAvailabilityCheckUpdate request including UE ID and S-NSSAI. The AMF may send the Nnsacf_NumberOfUEsPerSliceAvailabilityCheckUpdate request in a case where the AMF receives a Registration request message including the S-NSSAI in the Requested NSSAI from the UE. And then the AMF receives, from the NSACF, Nnsacf_NumberOfUEsPerSliceAvailabilityCheckUpdate response indicating that the UE is not allowed to use the S-NSSAI due to limitation of the quota, i.e. the maximum number of UEs has been reached or the number of the UEs registered with the network slice has exceeded the limitation of UE quota of the S-NSSAI.

In addition, the SMF sends, to the NSACF, Nnsacf_NumberOfPDUsPerSliceAvailabilityCheckUpdate request including the UE ID and the S-NSSAI. The SMF may send, to the NSACF, the Nnsacf_NumberOfPDUsPerSliceAvailabilityCheckUpdate request in a case where the SMF receives a PDU session establishment request message including the S-NSSAI. The SMF may send, to the NSACF, the Nnsacf_NumberOfPDUsPerSliceAvailabilityCheckUpdate request in a case where the AMF receives the Nnsacf_NumberOfUEsPerSliceAvailabilityCheckUpdate response and the AMF notifies the reception of the Nnsacf_NumberOfUEsPerSliceAvailabilityCheckUpdate response to the SMF.

And then the SMF receives, from the NSACF, Nnsacf_NumberOfPDUsPerSliceAvailabilityCheckUpdate response indicating that the PDU session is not allowed to establish due to limitation of the quota, i.e. the maximum number of PDU sessions has been reached or the number of the PDU sessions has exceeded the limitation of PDU session quota of the S-NSSAI.

In this case, the AMF sends, to the UE, a message including a reject cause, the S-NSSAI, and the BOT for UE and the SMF sends, to the UE, the BOT for PDU session.

For example, the AMF sends the message including the reject cause, the S-NSSAI and the BOT for UE in a case where the AMF receives the Nnsacf_NumberOfUEsPerSliceAvailabilityCheckUpdate response indicating that the UE is not allowed to use the S-NSSAI due to limitation of the quota.

For example, the SMF sends the message including the reject cause, the S-NSSAI and the BOT for PDU session in a case where the SMF receives the Nnsacf_NumberOfPDUsPerSliceAvailabilityCheckUpdate response indicating that the PDU session is not allowed to establish due to limitation of the quota.

For example the AMF sends the message including the reject cause, the S-NSSAI, the BOT for UE and the SMF sends the BOT for PDU session in a case where the AMF receives the Nnsacf_NumberOfUEsPerSliceAvailabilityCheckUpdate response indicating that the UE is not allowed to use the S-NSSAI due to limitation of quota the and the SMF receives Nnsacf_NumberOfPDUsPerSliceAvailabilityCheckUpdate response indicating that the PDU session is not allowed to establish due to limitation of the quota respectively.

The message sent to the UE may be a Registration Accept message, a Registration Reject message, a PDU Session Establishment Accept message, a PDU Session Establishment Reject message or any other NAS message.

The reject cause may have a value “Unsuccessful PDN connection establishment due to Quota control”, “Unsuccessful PDN connection establishment due to UE Quota control”, “Unsuccessful PDN connection establishment due to PDN connection Quota control” or any other notation for a reject cause with the purpose to reject the PDN connection establishment due to the number of the PDN connections associated with the network slice has reached or exceeded the maximum quota. The reject cause may have any other notation for a reject cause with the purpose to reject the PDN connection establishment due to the number of the UEs registered with the network slice has reached or exceeded the maximum quota. The reject cause may have a value “maximum number of UEs per network slice reached” or “maximum number of PDU Sessions per network slice reached”.

The BOT for UE is referred by the UE to suppress next attempt for the PDU session establishment to the same S-NSSAI. The BOT for PDU session is referred by the UE to suppress next attempt for the PDU session to the same S-NSSAI. Similarly, the BOT for UE is referred by the UE to suppress next attempt for the Registration procedure to the same S-NSSAI. The BOT for PDU session is referred by the UE to suppress next attempt for the Registration procedure to the same S-NSSAI.

When the UE receives the BOTs, the UE performs the following process if the UE has “S1 mode supported” in the 5GMM capability.
When an S-NSSAI in the Requested NSSAI was rejected in the Registration procedure, I.e. the UE receives the S-NSSAI in the Rejected NSSAI parameter together with the reject cause (e.g. “maximum number of UEs per network slice reached”) and the BOT for UE in the Registration Accept message or the Registration Reject message from the AMF, the UE finds an associated DNN or Application ID with the rejected S-NSSAI based on the Network Slice Selection Policy (NSSP) as described in NPL 7. The UE considers that the BOT for UE is applicable to the DNN. And the UE starts the BOT for UE.
When an S-NSSAI in the PDU Session Establishment Requested was rejected in the PDU Session Establishment procedure, I.e. the UE receives the rejected S-NSSAI with the reject cause (e.g. “maximum number of PDU Sessions per network slice reached”) and the BOT for PDU Session in the PDU Session Establishment Accept message, the PDU Session Establishment Reject message or any other NAS message from the AMF, the UE associates the rejected S-NSSAI with the DNN that is included in the PDU Session Establishment Request message. Alternatively, the UE finds an associated DNN or Application ID with the rejected S-NSSAI based on the Network Slice Selection Policy (NSSP) as described in NPL 7. The UE considers that the BOT for PDU Session is applicable to the DNN. And the UE starts the BOT for PDU session.

In one example the UE supporting NSAC feature sends, to the AMF, an indicator indicating that the UE supports NSAC feature in a registration request message. The AMF stores this information for the UE. If the AMF does not receive the indicator, or receives the indicator and the indicator indicating that the UE does not support the NSAC feature, then the AMF sends the S-NSSAI in rejected NSSAI with an existing 5GMM cause (e.g. 5GMM cause #22 “congestion”) and back off timer in the NAS message (e.g. Registration Accept or Registration Reject or configuration update command message) the if AMF receives Nnsacf_NumberOfUEsPerSliceAvailabilityCheckUpdate response message indicating S-NSSAI is not registered in the NSCAF as the maximum number of UEs is reached or exceeds for the S-NSSAI.

On receiving the NAS message from the AMF, the UE runs the timer T3346 with timer value set to back off timer. The UE does not send the S-NSSAI in the requested NSSAI while the timer is running. If the AMF determines that the UE supports NSAC feature, then the AMF sends a NAS message (e.g. Registration Accept or Registration Reject) containing the S-NSSAI in the Rejected NSSAI with a new cause indicating the maximum number of UEs reached for the S-NSSAI and a back off timer. Upon reception of the NAS message the UE follows the procedure as described in the above for the case when the registration to the S-NSSAI failed due to number of UEs reached or exceeded the threshold for the UE.

The AMF transmits the indicator to the SMF. When the SMF receives Nnsacf_NumberOfPDUsPerSliceAvailabilityCheckUpdate response message indicating that the number of PDU sessions reached the maximum value for the S-NSSAI and the indicator indicates that the UE does not support NSAC feature, the SMF sends PDU session establishment reject message containing an existing 5GSM cause (e.g. 5GSM #69—Insufficient resources for specific slice), the S-NSSAI and back off timer, otherwise the SMF sends a new 5GSM cause value indicating that UE is not allowed to initiate PDU session for the S-NSSAI. For example, when the SMF receives Nnsacf_NumberOfPDUsPerSliceAvailabilityCheckUpdate response message indicating that the number of PDU sessions reached the maximum value for the S-NSSAI and the indicator indicates that the UE supports NSAC feature, the SMF may send the new 5GSM cause value and a back off timer. The UE does not initiate PDU session for the S-NSSAI while the timer is running.

In one example when the AMF sends the indicator whether the UE supports NSAC feature to the UDM or the PCF in an existing message. When the UDM determines that the UE does not support NSAC feature based on either the UDM does not receive the indicator or the indicator is set to not supported, the UDM shall not configure the UE with the S-NSSAI subject to NSAC, otherwise the UDM configures the subscribed S-NSSAI subject to NSAC using an existing procedure. When the PCF determines that the UE does not support NSAC because the UDM does not receive the indicator or the indicator is set to not supported, the PCF shall not include rule corresponding the S-NSSAI subject to the NSAC, otherwise the PCF includes the S-NSSAI subject to the NSAC.

1. UE moves from the 5GS to the EPS within the same PLMN or ePLMN with the BOTs running. The UE may be in 5GMM-CONNECTED mode when the UE is handed over to the EPS or in 5GMM-IDLE mode when the UE performs idle mode mobility procedure from 5GS to EPS. For example, the UE may perform inter-system change or inter-system handover from the 5GS to the EPS within the same PLMN or ePLMN while the BOTs are running.

The UE does not perform the ATTACH procedure, the TAU procedure or the UE requested PDN connectivity procedure related to the APN as far as the BOT for UE as to the DNN equivalent to the APN is running.

The UE does not perform the ATTACH procedure, the TAU procedure or the UE requested PDN connectivity procedure related to the APN as far as the BOT for PDU session as to the DNN equivalent to the APN is running.

For example, the UE may store mapping information APNs and DNNs. For example, the UE finds, based on the mapping information, the APN corresponding to or equivalent to the DNN, then the UE does not perform the ATTACH procedure, the TAU procedure or the UE requested PDN connectivity procedure related to the APN as far as the BOT for UE or the BOT for PDU session is running.

The UE does not perform the ATTACH procedure, the TAU procedure or the UE requested PDN connectivity procedure related to the APN as far as the BOT for UE and the BOT for PDU session as to the DNN equivalent to the APN are running.

For example, the UE may store mapping information APNs and DNNs. For example, the UE finds, based on the mapping information, the APN corresponding to or equivalent to the DNN, then the UE does not perform the ATTACH procedure, the TAU procedure or the UE requested PDN connectivity procedure related to the APN as far as the BOT for UE and the BOT for PDU session are running.

2-1. The UE may perform the ATTACH procedure with ESM message container that contains the APN equivalent to the DNN in 5GS, after the BOT for UE for the associated DNN expires.

The UE may perform the ATTACH procedure with ESM message container that contains the APN equivalent to the DNN in 5GS, after the BOT for PDU Session for the associated DNN expires.

The UE may perform the ATTACH procedure with ESM message container that contains the APN equivalent to the DNN in 5GS, after both the BOT for UE and the BOT for PDU Session for the associated DNN expire.

2-2. The UE may perform the TAU procedure with ESM message container that contains the APN equivalent to the DNN in 5GS, after the BOT for UE for the associated DNN expires.

The UE may perform the TAU procedure with ESM message container that contains the APN equivalent to the DNN in 5GS, after the BOT for PDU Session for the associated DNN expires.

The UE may perform the TAU procedure with ESM message container that contains the APN equivalent to the DNN in 5GS, after both the BOT for UE and the BOT for PDU Session for the associated DNN expire.

2-3. The UE may perform the UE requested PDN connectivity procedure with the APN equivalent to the DNN in 5GS, after the BOT for UE for the associated DNN expires.

The UE may perform the UE requested PDN connectivity procedure with the APN equivalent to the DNN in 5GS, after the BOT for PDU Session for the associated DNN expires.

The UE may perform the UE requested PDN connectivity procedure with the APN equivalent to the DNN in 5GS, after both the BOT for UE and the BOT for PDU Session for the associated DNN expire.

For example, when the UE receives the BOT for UE, the UE starts the BOT for UE.

For example, when the UE receives the BOT for PDU session, the UE starts the BOT for PDU session.

For example, when the UE receives the BOT for UE and the BOT for PDU session, the UE starts the BOT for UE and the BOT for PDU session.

### <Variant 1 of the Aspect 2>

The network during the registration procedure for a S-NSSAI which is subject to NSAC may indicate to the UE in an existing NAS message or a new NAS message during the registration procedure whether the BOT for UE is applicable to the EPS or not.

For example, in a case where the NSACF indicates, to the AMF, whether the BOT for UE is applicable to the EPS or not, the AMF may indicate to the UE whether the BOT for UE is applicable to the EPS or not.

For example, in a case where the AMF decides, based on local policy or UE subscription information, to indicate whether the BOT for UE is applicable to the EPS or not, the AMF may indicate to the UE whether the BOT for UE is applicable to the EPS or not.

For example, the AMF determines, based on local policy or UE subscription information, whether the BOT for UE is applicable to the EPS or not, and the AMF may indicate to the UE whether the BOT for UE is applicable to the EPS or not.

If it is indicated that the BOT of UE is applicable to the EPS then the UE shall follow the procedure as defined in the Aspect 2, otherwise the UE may initiate PDN connection establishment procedure for the APN corresponding to the DNN in 5GS when the UE is registered to the EPS (e.g. the UE may ignore or may not consider the BOT for UE for the PDN connection establishment procedure for the APN corresponding to or equivalent to the DNN in 5GS).

The network during the PDU session establishment procedure for the S-NSSAI which is subject to NSAC may indicate to the UE in an existing NAS message or a new NAS message during the PDU session establishment procedure whether the BOT for PDU session is applicable to the EPS or not.

For example, in a case where the NSACF indicates, to the AMF, whether the BOT for PDU session is applicable to the EPS or not, the AMF may indicate to the UE whether the BOT for PDU session is applicable to the EPS or not.

For example, the AMF decides, based on local policy or UE subscription information, to indicate whether the BOT for PDU session is applicable to the EPS or not, the AMF may indicate to the UE whether the BOT for PDU session is applicable to the EPS or not.

For example, the AMF determines, based on local policy or UE subscription information, whether the BOT for PDU session is applicable to the EPS or not, and the AMF may indicate to the UE whether the BOT for PDU session is applicable to the EPS or not.

If it is indicated that the BOT of PDU session is applicable to the EPS then the UE shall follow the procedure as defined in the Aspect 2, otherwise the UE may initiate PDN connection establishment procedure for the APN corresponding to the DNN in 5GS when the UE is registered to the EPS (e.g. the UE may ignore or may not consider the BOT for PDU session for the PDN connection establishment procedure for the APN corresponding to or equivalent to the DNN in 5GS).

### <Variant 2 of Aspect 2>

If the UE was rejected for a registration request in 5GS via 3GPP access for a S-NSSAI with the reject cause (e.g. ‘the number of registered UEs with the network slice reached the maximum number of UEs’) and the BOT for UE, or the UE was rejected for PDU Sessions establishment on the S-NSSAI while on the 3GPP access with the reject cause (e.g. ‘the number of the PDU Sessions established on the network slice reached the maximum number of PDU Sessions’) and the BOT for PDU session, or the UE was rejected for the both with the both BOTs, the UE may take following actions:
The UE shall not initiate another registration procedure with the rejected S-NSSAI via non-3GPP access to the same PLMN or equivalent PLMN while the BOT for UE is running.
The UE shall not initiate another PDU Session establishment procedure via non-3GPP access to the same PLMN or equivalent PLMN while the BOT for PDU session is running.
The UE may initiate another registration procedure with the rejected S-NSSAI via non-3GPP access to the same PLMN or equivalent PLMN while the BOT for UE is running.
The UE may initiate another PDU Session establishment procedure via non-3GPP access to the same PLMN or equivalent PLMN while the BOT for PDU session is running.

### <Variant 3 of Aspect 2>

If the UE was rejected for a registration request in 5GS via non-3GPP access for a S-NSSAI with the reject cause (e.g. ‘the number of registered UEs with the network slice reached the maximum number of UEs’) and the BOT for UE, or the UE was rejected for PDU Sessions establishment on the S-NSSAI while on the non-3GPP access with the reject cause (e.g. ‘the number of the PDU Sessions established on the network slice reached the maximum number of PDU Sessions’) and the BOT for PDU session, or the UE was rejected for the both with the both BOTs, the UE may take following actions:
The UE shall not initiate another registration procedure with the rejected S-NSSAI via 3GPP access to the same PLMN or equivalent PLMN while the BOT for UE is running.
The UE shall not initiate another PDU Session establishment procedure via 3GPP access to the same PLMN or equivalent PLMN while the BOT for PDU session is running.
The UE may initiate another registration procedure with the rejected S-NSSAI via 3GPP access to the same PLMN or equivalent PLMN while the BOT for UE is running.
The UE may initiate another PDU Session establishment procedure via 3GPP access to the same PLMN or equivalent PLMN while the BOT for PDU session is running.

For example, the Aspect 2 and Variants of the Aspect 2 can solve the problem that the UE behavior is unclear in case that the PDN connection establishment or the PDU session establishment fails due to Network slice admission control

For example, the Aspect 2 and Variants of the Aspect 2 can solve the problem that it is unclear whether or not the UE has to be backed-off till next attempt for the PDN connection establishment or the PDU session establishment.

<System overview>

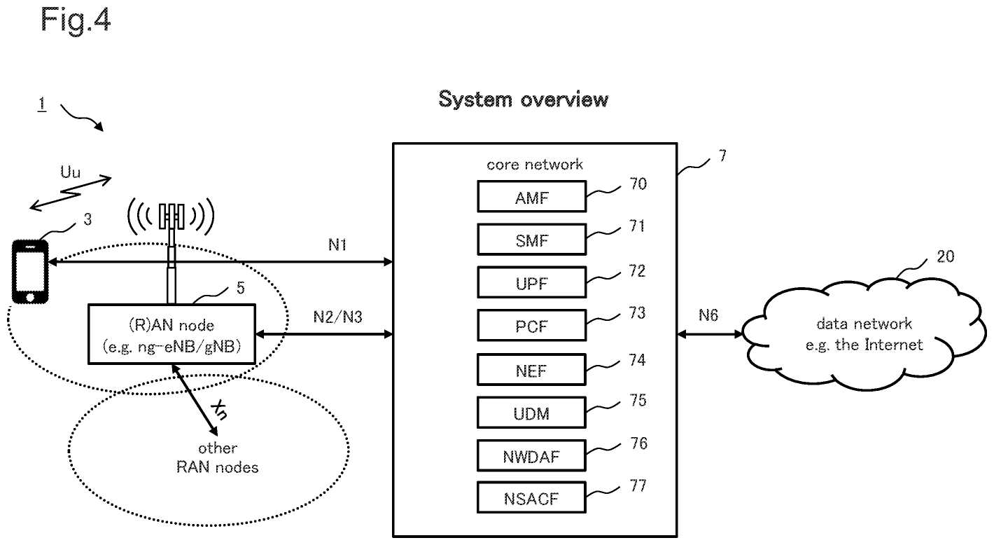

FIG. 4 schematically illustrates a telecommunication system 1 for a mobile (cellular or wireless) device (known as a user equipment (UE)) to which the above aspects are applicable.

The telecommunication system 1 represents a system overview in which an end to end communication is possible. For example, UE 3 (or user equipment, ‘mobile device’ 3) communicates with other UEs 3 or service servers in the data network 20 via respective (R)AN nodes 5 and a core network 7.

The (R)AN node 5 supports any radio accesses including a 5G radio access technology (RAT), an E-UTRA radio access technology, a beyond 5G RAT, a 6G RAT and non-3GPP RAT including wireless local area network (WLAN) technology as defined by the Institute of Electrical and Electronics Engineers (IEEE).

The (R)AN node 5 may split into a Radio Unit (RU), Distributed Unit (DU) and Centralized Unit (CU).

In some aspects, each of the units may be connected to each other and structure the (R)AN node 5 by adopting an architecture as defined by the Open RAN (O-RAN) Alliance, where the units above are referred to as O-RU, O-DU and O-CU respectively.

The (R)AN node 5 may be split into one or more control plane functions and one or more user plane functions. Further, multiple user plane functions can be allocated to support a communication. In some aspects, user traffic may be distributed to multiple user plane functions and user traffic over each user plane function is aggregated in both the UE 3 and the (R)AN node 5. This split architecture may be called ‘dual connectivity’ or ‘Multi connectivity’.

The (R)AN node 5 can also support a communication using the satellite access. In some aspects, the (R)AN node 5 may support a satellite access and a terrestrial access.

In addition, the (R)AN node 5 can also be referred as an access node for a non-wireless access. The non-wireless access includes a fixed line access as defined by the Broadband Forum (BBF) and an optical access as defined by the Innovative Optical and Wireless Network (IOWN).

The core network 7 may include logical nodes (or ‘functions’) for supporting a communication in the telecommunication system 1. For example, the core network 7 may be 5G Core Network (5GC) that includes, amongst other functions, control plane functions and user plane functions. Each function in a logical node can be considered as a network function. The network function may be provided to another node by adapting the Service Based Architecture (SBA). In addition, for example, the core network 7 may include control plane functions and user plane functions in Evolved Packet Core (EPC). For example, the core network 7 includes MME, SGW-C, and PGW-C. The MME may include a transceiver circuit which is operable to transmit signals to and to receive signals from other nodes (including nodes in the core network 7) via a network interface, and a controller which is operable to control the operation of the MME in accordance with software stored in a memory of the MME. The SGW-C may include a transceiver circuit which is operable to transmit signals to and to receive signals from other nodes (including nodes in the core network 7) via a network interface, and a controller which is operable to control the operation of the SGW-C in accordance with software stored in a memory of the SGW-C.

A Network Function can be deployed as distributed, redundant, stateless, and scalable that provides the services from several locations and several execution instances in each location by adapting the network virtualization technology as defined by the European Telecommunications Standards Institute, Network Functions Virtualization (ETSI NFV).

The core network 7 may support the Non-Public Network (NPN). The NPN may be a Stand-alone Non-Public Network (SNPN) or a Public Network Integrated NPN (PNI-NPN).

As is well known, a UE 3 may enter and leave the areas (i.e. radio cells) served by the (R)AN node 5 as the UE 3 is moving around in the geographical area covered by the telecommunication system 1.

In order to keep track of the UE 3 and to facilitate movement between the different (R)AN nodes 5, the core network 7 comprises at least one access and mobility management function (AMF) 70. The AMF 70 is in communication with the (R)AN node 5 coupled to the core network 7. In some core networks, a mobility management entity (MME) or a mobility management node for beyond 5G or a mobility management node for 6G may be used instead of the AMF 70.

The core network 7 also includes, amongst others, a Session Management Function (SMF) 71, a User Plane Function (UPF) 72, a Policy Control Function (PCF) 73, a Network Exposure Function (NEF) 74, a Unified Data Management (UDM) 75, a Network Data Analytics Function (NWDAF) 76 and NSACF (Network Slice Admission Control Function) 77. In addition, the core network 7 may also include SMF+PGW-C. When the UE 3 is roaming to a visited Public Land Mobile Network (VPLMN), a home Public Land Mobile Network (HPLMN) of the UE 3 provides the UDM 75 and at least some of the functionalities of the SMF 71, UPF 72, and PCF 73 for the roaming-out UE 3.

The UE 3 and a respective serving (R)AN node 5 are connected via an appropriate air interface (for example the so-called “Uu” interface and/or the like). Neighboring (R)AN nodes 5 are connected to each other via an appropriate (R)AN node 5 to (R)AN node interface (such as the so-called “Xn” interface and/or the like). Each (R)AN node 5 is also connected to nodes in the core network 7 (such as the so-called core network nodes) via an appropriate interface (such as the so-called “N2”/“N3” interface(s) and/or the like). From the core network 7, connection to a data network 20 is also provided. The data network 20 can be an internet, a public network, an external network, a private network or an internal network of the PLMN. In case that the data network 20 is provided by a PLMN operator or Mobile Virtual Network Operator (MVNO), the IP Multimedia Subsystem (IMS) service may be provided by that data network 20. The UE 3 can be connected to the data network 20 using IPv4, IPV6, IPv4v6, Ethernet or unstructured data type. The “Uu” interface may include a Control plane and User plane.

The User plane of the Uu interface is responsible to convey user traffic between the UE 3 and a serving (R)AN node 5. The User plane of the Uu interface may have a layered structure with SDAP, PDCP, RLC and MAC sublayer over the physical connection.

The Control plane of the Uu interface is responsible to establish, modify and release a connection between the UE 3 and a serving (R)AN node 5. The Control plane of the Uu interface may have a layered structure with RRC, PDCP, RLC and MAC sublayers over the physical connection.

For example, the following messages are communicated over the RRC layer to support AS signaling.
RRC Setup Request message: This message is sent from the UE 3 to the (R)AN node 5. In addition to the parameters that are disclosed by Aspects in this disclosure, any of the following parameters may be included together in the RRC Setup Request message.
   establishmentCause and ue-Identity. The ue-Identity may have a value of ng-5G-S-TMSI-Part1 or random Value.
RRC Setup message: This message is sent from the (R)AN node 5 to the UE 3. In addition to the parameters that are disclosed by Aspects in this disclosure, any of the following parameters may be included together in the RRC Setup message.
   masterCellGroup and radioBearerConfig
RRC Setup Complete message: This message is sent from the UE 3 to the (R)AN node 5. In addition to the parameters that are disclosed by Aspects in this disclosure, any of the following parameters may be included together in the RRC Setup Complete message.
   guami-Type, iab-NodeIndication, idleMeas Available, mobility State, ng-5G-S-TMSI-Part2, registeredAMF, selectedPLMN-Identity

The UE 3 and the AMF 70 are connected via an appropriate interface (for example the so-called N1 interface and/or the like). The N1 interface is responsible for providing a communication between the UE 3 and the AMF 70 to support NAS signaling. The N1 interface may be established over a 3GPP access and over a non-3GPP access. For example, the following messages are communicated over the N1 interface.
Registration Request message: This message is sent from the UE 3 to the AMF 70. In addition to the parameters that are disclosed by Aspects in this disclosure, any of the following parameters may be included together in the Registration Request message.
   5GS registration type, ngKSI, 5GS mobile identity, Non-current native NAS key set identifier, 5GMM capability, UE security capability, Requested NSSAI, Last visited registered TAI, S1 UE network capability, Uplink data status, PDU session status, MICO indication, UE status, Additional GUTI, Allowed PDU session status, UE's usage setting, Requested DRX parameters, EPS NAS message container, LADN indication, Payload container type, Payload container, Network slicing indication, 5GS update type, Mobile station classmark 2, Supported codecs, NAS message container, EPS bearer context status, Requested extended DRX parameters, T3324 value, UE radio capability ID, Requested mapped NSSAI, Additional information requested, Requested WUS assistance information, N5GC indication and Requested NB-N1 mode DRX parameters.
Registration Accept message: This message is sent from the AMF 70 to the UE 3. In addition to the parameters that are disclosed by Aspects in this disclosure, any of the following parameters may be included together in the Registration Accept message.
   5GS registration result, 5G-GUTI, Equivalent PLMNs, TAI list, Allowed NSSAI, Rejected NSSAI, Configured NSSAI, 5GS network feature support, PDU session status, PDU session reactivation result, PDU session reactivation result error cause, LADN information, MICO indication, Network slicing indication, Service area list, T3512 value, Non-3GPP de-registration timer value, T3502 value, Emergency number list, Extended emergency number list, SOR transparent container, EAP message, NSSAI inclusion mode, Operator-defined access category definitions, Negotiated DRX parameters, Non-3GPP NW policies, EPS bearer context status, Negotiated extended DRX parameters, T3447 value, T3448 value, T3324 value, UE radio capability ID, UE radio capability ID deletion indication, Pending NSSAI, Ciphering key data, CAG information list, Truncated 5G-S-TMSI configuration, Negotiated WUS assistance information, Negotiated NB-N1 mode DRX parameters and Extended rejected NSSAI.
Registration Complete message: This message is sent from the UE 3 to the AMF 70. In addition to the parameters that are disclosed by Aspects in this disclosure, the following parameter may be included together in the Registration Complete message.
   SOR transparent container.
Authentication Request message: This message is sent from the AMF 70 to the UE 3. In addition to the parameters that are disclosed by Aspects in this disclosure, any of the following parameters may be included together in the Authentication Request message.
   ngKSI, ABBA, Authentication parameter RAND (5G authentication challenge), Authentication parameter AUTN (5G authentication challenge) and EAP message.
Authentication Response message: This message is sent from the UE 3 to the AMF 70. In addition to the parameters that are disclosed by Aspects in this disclosure, any of the following parameters may be populated together in the Authentication Response message.
   Authentication response message identity, Authentication response parameter and EAP message.
Authentication Result message: This message is sent from the AMF 70 to the UE 3. In addition to the parameters that are disclosed by Aspects in this disclosure, any of the following parameters may be populated together in the Authentication Result message.
   ngKSI, EAP message and ABBA.
Authentication Failure message: This message is sent from the UE 3 to the AMF 70. In addition to the parameters that are disclosed by Aspects in this disclosure, any of the following parameters may be populated together in the Authentication Failure message.
   Authentication failure message identity, 5GMM cause and Authentication failure parameter.
Authentication Reject message: This message is sent from the AMF 70 to the UE 3. In addition to the parameters that are disclosed by Aspects in this disclosure, the following parameter may be populated together in the Authentication Reject message.
   EAP message.
Service Request message: This message is sent from the UE 3 to the AMF 70. In addition to the parameters that are disclosed by Aspects in this disclosure, any of the following parameters may be populated together in the Service Request message.
   ngKSI, Service type, 5G-S-TMSI, Uplink data status, PDU session status, Allowed PDU session status, NAS message container.
Service Accept message: This message is sent from the AMF 70 to the UE 3. In addition to the parameters that are disclosed by Aspects in this disclosure, any of the following parameters may be populated together in the Service Accept message.
   PDU session status, PDU session reactivation result, PDU session reactivation result error cause, EAP message and T3448 value.
Service Reject message: This message is sent from the AMF 70 to the UE 3. In addition to the parameters that are disclosed by Aspects in this disclosure, any of the following parameters may be populated together in the Service Reject message.
   5GMM cause, PDU session status, T3346 value, EAP message, T3448 value and CAG information list.
Configuration Update Command message: This message is sent from the AMF 70 to the UE 3. In addition to the parameters that are disclosed by Aspects in this disclosure, any of the following parameters may be populated together in the Configuration Update Command message.
   Configuration update indication, 5G-GUTI, TAI list, Allowed NSSAI, Service area list, Full name for network, Short name for network, Local time zone, Universal time and local time zone, Network daylight saving time, LADN information, MICO indication, Network slicing indication, Configured NSSAI, Rejected NSSAI, Operator-defined access category definitions, SMS indication, T3447 value, CAG information list, UE radio capability ID, UE radio capability ID deletion indication, 5GS registration result, Truncated 5G-S-TMSI configuration, Additional configuration indication and Extended rejected NSSAI.
Configuration Update Complete message: This message is sent from the UE 3 to the AMF 70. In addition to the parameters that are disclosed by Aspects in this disclosure, the following parameter may be populated together in the Configuration Update Complete message.
   Configuration update complete message identity.

### <User Equipment (UE)>

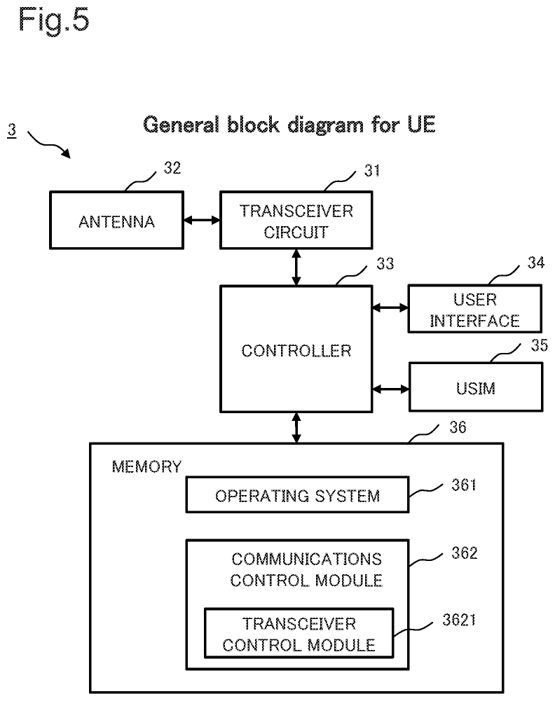

FIG. 5 is a block diagram illustrating the main components of the UE 3 (mobile device 3). As shown, the UE 3 includes a transceiver circuit 31 which is operable to transmit signals to and to receive signals from the connected node(s) via one or more antennas 32. Further, the UE 3 may include a user interface 34 for inputting information from outside or outputting information to outside. Although not necessarily shown in the Figure, the UE 3 may have all the usual functionality of a conventional mobile device and this may be provided by any one or any combination of hardware, software and firmware, as appropriate. Software may be pre-installed in the memory and/or may be downloaded via the telecommunication network or from a removable data storage device (e.g. a removable memory device (RMD)), for example. A controller 33 controls the operation of the UE 3 in accordance with software stored in a memory 36. The software includes, among other things, an operating system 361 and a communications control module 362 having at least transceiver control module 3621. The communications control module 362 (using its transceiver control module 3621) is responsible for handling (generating/sending/receiving) signalling and uplink/downlink data packets between the UE 3 and other nodes, such as the (R)AN node 5 and the AMF 10. Such signalling may include, for example, appropriately formatted signalling messages (e.g. a registration request message and associated response messages) relating to access and mobility management procedures (for the UE 3). The controller 33 interworks with one or more Universal Subscriber Identity Module (USIM) 35. If there are multiple USIMs 35 equipped, the controller 33 may activate only one USIM 35 or may activate multiple USIMs 35 at the same time.

The UE 3 may, for example, support the Non-Public Network (NPN), The NPN may be a Stand-alone Non-Public Network (SNPN) or a Public Network Integrated NPN (PNI-NPN).

The UE 3 may, for example, be an item of equipment for production or manufacture and/or an item of energy related machinery (for example equipment or machinery such as: boilers; engines: turbines: solar panels: wind turbines: hydroelectric generators: thermal power generators: nuclear electricity generators: batteries: nuclear systems and/or associated equipment; heavy electrical machinery: pumps including vacuum pumps; compressors: fans: blowers; oil hydraulic equipment: pneumatic equipment: metal working machinery: manipulators: robots and/or their application systems: tools: molds or dies: rolls: conveying equipment: elevating equipment: materials handling equipment; textile machinery: sewing machines: printing and/or related machinery: paper converting machinery: chemical machinery; mining and/or construction machinery and/or related equipment; machinery and/or implements for agriculture, forestry and/or fisheries; safety and/or environment preservation equipment; tractors; precision bearings; chains; gears; power transmission equipment; lubricating equipment; valves; pipe fittings; and/or application systems for any of the previously mentioned equipment or machinery etc.).

The UE 3 may, for example, be an item of transport equipment (for example transport equipment such as: rolling stocks; motor vehicles; motor cycles; bicycles; trains; buses; carts; rickshaws; ships and other watercraft; aircraft; rockets; satellites; drones; balloons etc.).

The UE 3 may, for example, be an item of information and communication equipment (for example information and communication equipment such as: electronic computer and related equipment; communication and related equipment; electronic components etc.).

The UE 3 may, for example, be a refrigerating machine, a refrigerating machine applied product, an item of trade and/or service industry equipment, a vending machine, an automatic service machine, an office machine or equipment, a consumer electronic and electronic appliance (for example a consumer electronic appliance such as: audio equipment; video equipment; a loud speaker; a radio; a television; a microwave oven; a rice cooker; a coffee machine; a dishwasher; a washing machine; a dryer; an electronic fan or related appliance; a cleaner etc.).

The UE 3 may, for example, be an electrical application system or equipment (for example an electrical application system or equipment such as: an x-ray system; a particle accelerator; radio isotope equipment: sonic equipment; electromagnetic application equipment: electronic power application equipment etc.).

The UE 3 may, for example, be an electronic lamp, a luminaire, a measuring instrument, an analyzer, a tester, or a surveying or sensing instrument (for example a surveying or sensing instrument such as: a smoke alarm; a human alarm sensor; a motion sensor; a wireless tag etc.), a watch or clock, a laboratory instrument, optical apparatus, medical equipment and/or system, a weapon, an item of cutlery, a hand tool, or the like.

The UE 3 may, for example, be a wireless-equipped personal digital assistant or related equipment (such as a wireless card or module designed for attachment to or for insertion into another electronic device (for example a personal computer, electrical measuring machine)).

The UE 3 may be a device or a part of a system that provides applications, services, and solutions described below, as to “internet of things (IoT)”, using a variety of wired and/or wireless communication technologies.

Internet of Things devices (or “things”) may be equipped with appropriate electronics, software, sensors, network connectivity, and/or the like, which enable these devices to collect and exchange data with each other and with other communication devices. IoT devices may comprise automated equipment that follow software instructions stored in an internal memory. IoT devices may operate without requiring human supervision or interaction. IoT devices might also remain stationary and/or inactive for a long period of time. IoT devices may be implemented as a part of a (generally) stationary apparatus. IoT devices may also be embedded in non-stationary apparatus (e.g. vehicles) or attached to animals or persons to be monitored/tracked.

It will be appreciated that IoT technology can be implemented on any communication devices that can connect to a communications network for sending/receiving data, regardless of whether such communication devices are controlled by human input or software instructions stored in memory.

It will be appreciated that IoT devices are sometimes also referred to as Machine-Type Communication (MTC) devices or Machine-to-Machine (M2M) communication devices or Narrow Band-IoT UE (NB-IoT UE). It will be appreciated that a UE 3 may support one or more IoT or MTC applications.

The UE 3 may be a smart phone or a wearable device (e.g. smart glasses, a smart watch, a smart ring, or a hearable device).

The UE 3 may be a car, or a connected car, or an autonomous car, or a vehicle device, or a motorcycle or V2X (Vehicle to Everything) communication module (e.g. Vehicle to Vehicle communication module, Vehicle to Infrastructure communication module, Vehicle to People communication module and Vehicle to Network communication module).

### <(R)AN Node>

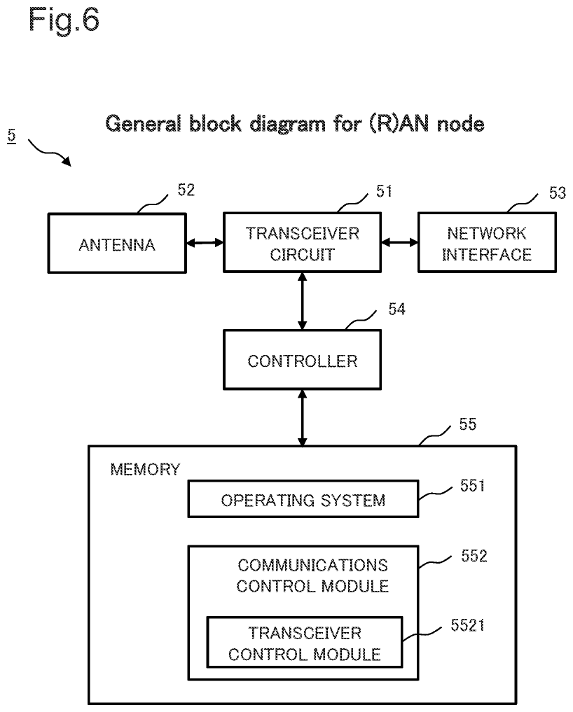

FIG. 6 is a block diagram illustrating the main components of an exemplary (R)AN node 5, for example a base station (‘eNB’ in LTE, ‘gNB’ in 5G, a base station for 5G beyond, a base station for 6G). As shown, the (R)AN node 5 includes a transceiver circuit 51 which is operable to transmit signals to and to receive signals from connected UE(s) 3 via one or more antennas 52 and to transmit signals to and to receive signals from other network nodes (either directly or indirectly) via a network interface 53. A controller 54 controls the operation of the (R)AN node 5 in accordance with software stored in a memory 55. Software may be pre-installed in the memory and/or may be downloaded via the telecommunication network or from a removable data storage device (e.g an RMD), for example.

The software includes, among other things, an operating system 551 and a communications control module 552 having at least a transceiver control module 5521.

The communications control module 552 (using its transceiver control sub-module) is responsible for handling (generating/sending/receiving) signalling between the (R)AN node 5 and other nodes, such as the UE 3, another (R)AN node 5, the AMF 70 and the UPF 72 (e.g. directly or indirectly). The signalling may include, for example, appropriately formatted signalling messages relating to a radio connection and a connection with the core network 7 (for a particular UE 3), and in particular, relating to connection establishment and maintenance (e.g. RRC connection establishment and other RRC messages), NG Application Protocol (NGAP) messages (i.e. messages by N2 reference point) and Xn application protocol (XnAP) messages (i.e. messages by Xn reference point), etc. Such signalling may also include, for example, broadcast information (e.g. Master Information and System information) in a sending case.

The controller 54 is also configured (by software or hardware) to handle related tasks such as, when implemented, UE mobility estimation and/or moving trajectory estimation.

The (R)AN node 5 may support the Non-Public Network (NPN), The NPN may be a Stand-alone Non-Public Network (SNPN) or a Public Network Integrated NPN (PNI-NPN).

### <System Overview of (R)AN Node 5 Based on O-RAN Architecture>

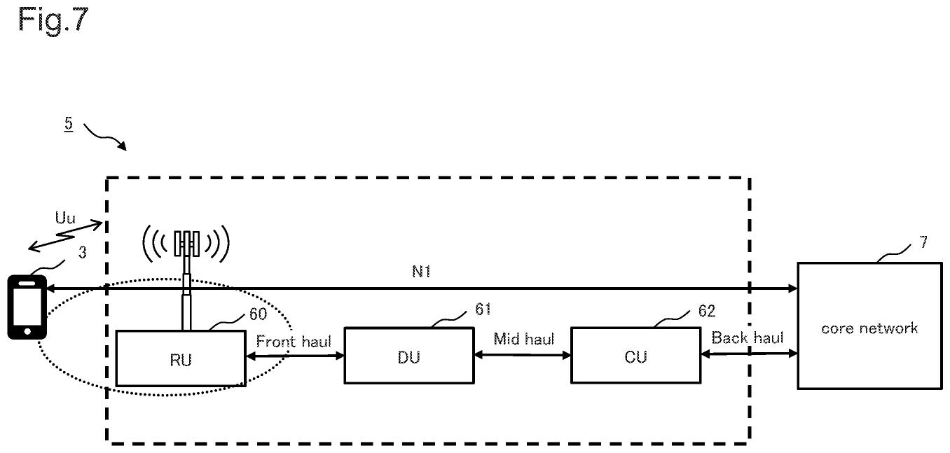

FIG. 7 schematically illustrates a (R)AN node 5 based on O-RAN architecture to which the (R)AN node 5 aspects are applicable.

The (R)AN node 5 based on O-RAN architecture represents a system overview in which the (R)AN node is split into a Radio Unit (RU) 60, Distributed Unit (DU) 61 and Centralized Unit (CU) 62. In some aspects, each unit may be combined. For example, the RU 60 can be integrated/combined with the DU 61 as an integrated/combined unit, the DU 61 can be integrated/combined with the CU 62 as another integrated/combined unit. Any functionality in the description for a unit (e.g. one of RU 60, DU 61 and CU 62) can be implemented in the integrated/combined unit above. Further, CU 62 can separate into two functional units such as CU Control plane (CP) and CU User plane (UP). The CU CP has a control plane functionality in the (R)AN node 5. The CU UP has a user plane functionality in the (R)AN node 5. Each CU CP is connected to the CU UP via an appropriate interface (such as the so-called “E1” interface and/or the like).

The UE 3 and a respective serving RU 60 are connected via an appropriate air interface (for example the so-called “Uu” interface and/or the like). Each RU 60 is connected to the DU 61 via an appropriate interface (such as the so-called “Front haul”, “Open Front haul”, “F1” interface and/or the like). Each DU 61 is connected to the CU 62 via an appropriate interface (such as the so-called “Mid haul”, “Open Mid haul”, “E2” interface and/or the like). Each CU 62 is also connected to nodes in the core network 7 (such as the so-called core network nodes) via an appropriate interface (such as the so-called “Back haul”, “Open Back haul”, “N2”/“N3” interface(s) and/or the like). In addition, a user plane part of the DU 61 can also be connected to the core network nodes 7 via an appropriate interface (such as the so-called “N3” interface(s) and/or the like).

Depending on functionality split among the RU 60, DU 61 and CU 62, each unit provides some of the functionality that is provided by the (R)AN node 5. For example, the RU 60 may provide a functionality to communicate with a UE 3 over air interface, the DU 61 may provide functionalities to support MAC layer and RLC layer, the CU 62 may provide functionalities to support PDCP layer, SDAP layer and RRC layer.

### <Radio Unit (RU)>

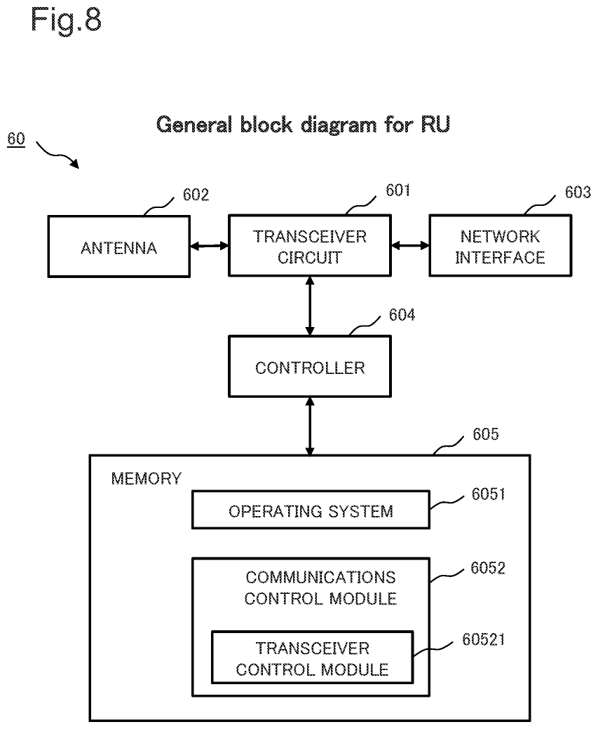

FIG. 8 is a block diagram illustrating the main components of an exemplary RU 60, for example a RU part of base station (‘eNB’ in LTE, ‘gNB’ in 5G, a base station for 5G beyond, a base station for 6G). As shown, the RU 60 includes a transceiver circuit 601 which is operable to transmit signals to and to receive signals from connected UE(s) 3 via one or more antennas 602 and to transmit signals to and to receive signals from other network nodes or network unit (either directly or indirectly) via a network interface 603. A controller 604 controls the operation of the RU 60 in accordance with software stored in a memory 605. Software may be pre-installed in the memory and/or may be downloaded via the telecommunication network or from a removable data storage device (e.g. a removable memory device (RMD)), for example. The software includes, among other things, an operating system 6051 and a communications control module 6052 having at least a transceiver control module 60521.

The communications control module 6052 (using its transceiver control sub-module) is responsible for handling (generating/sending/receiving) signalling between the RU 60 and other nodes or units, such as the UE 3, another RU 60 and DU 61 (e.g. directly or indirectly). The signalling may include, for example, appropriately formatted signalling messages relating to a radio connection and a connection with the RU 60 (for a particular UE 3), and in particular, relating to MAC layer and RLC layer.

The controller 604 is also configured (by software or hardware) to handle related tasks such as, when implemented, UE mobility estimates and/or moving trajectory estimation.

The RU 60 may support the Non-Public Network (NPN), The NPN may be a Stand-alone Non-Public Network (SNPN) or a Public Network Integrated NPN (PNI-NPN).

As described above, the RU 60 can be integrated/combined with the DU 61 as an integrated/combined unit. Any functionality in the description for the RU 60 can be implemented in the integrated/combined unit above.

### <Distributed Unit (DU)>

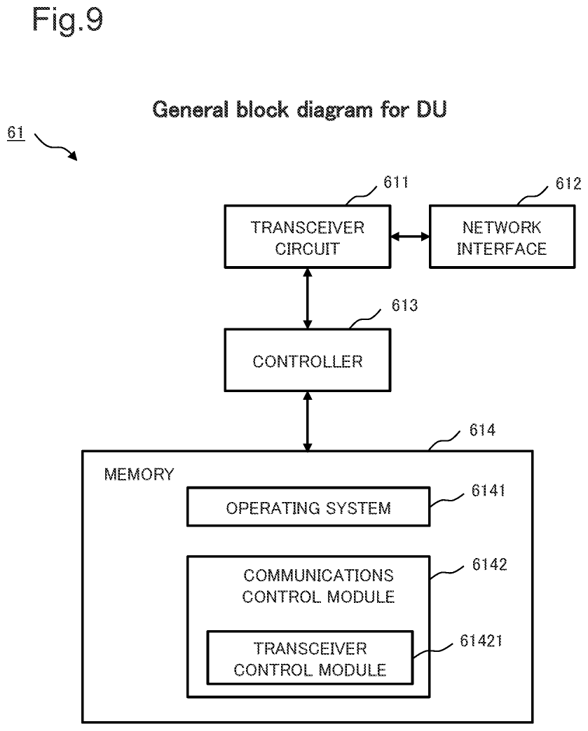

FIG. 9 is a block diagram illustrating the main components of an exemplary DU 61, for example a DU part of a base station (‘eNB’ in LTE, ‘gNB’ in 5G, a base station for 5G beyond, a base station for 6G). As shown, the apparatus includes a transceiver circuit 611 which is operable to transmit signals to and to receive signals from other nodes or units (including the RU 60) via a network interface 612.

A controller 613 controls the operation of the DU 61 in accordance with software stored in a memory 614. Software may be pre-installed in the memory 614 and/or may be downloaded via the telecommunication network or from a removable data storage device (e.g. a removable memory device (RMD)), for example. The software includes, among other things, an operating system 6141 and a communications control module 6142 having at least a transceiver control module 61421. The communications control module 6142 (using its transceiver control module 61421 is responsible for handling (generating/sending/receiving) signalling between the DU 61 and other nodes or units, such as the RU 60 and other nodes and units.

The DU 61 may support the Non-Public Network (NPN), The NPN may be a Stand-alone Non-Public Network (SNPN) or a Public Network Integrated NPN (PNI-NPN).

As described above, the DU 61 can be integrated/combined with the RU 60 or CU 62 as an integrated/combined unit. Any functionality in the description for DU 61 can be implemented in one of the integrated/combined unit above.

### <Centralized Unit (CU)>

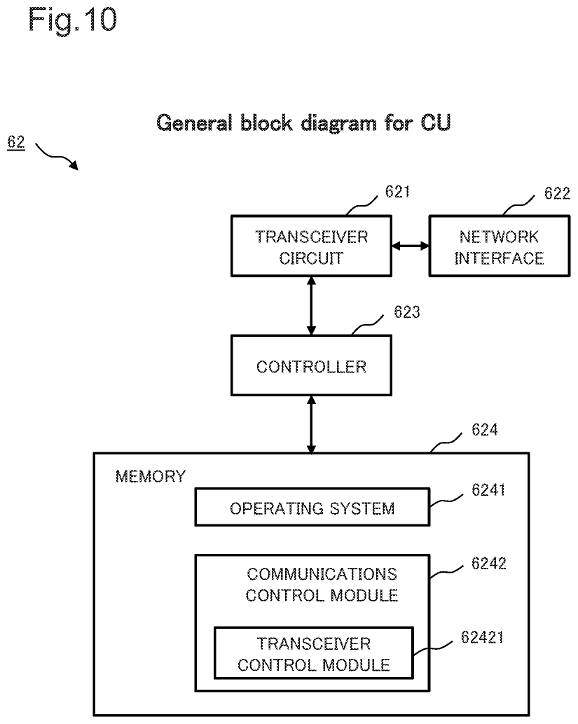

FIG. 10 is a block diagram illustrating the main components of an exemplary CU 62, for example a CU part of base station (‘eNB’ in LTE, ‘gNB’ in 5G, a base station for 5G beyond, a base station for 6G). As shown, the apparatus includes a transceiver circuit 621 which is operable to transmit signals to and to receive signals from other nodes or units (including the DU 61) via a network interface 622.

A controller 623 controls the operation of the CU 62 in accordance with software stored in a memory 624. Software may be pre-installed in the memory 624 and/or may be downloaded via the telecommunication network or from a removable data storage device (e.g. a removable memory device (RMD)), for example. The software includes, among other things, an operating system 6241 and a communications control module 6242 having at least a transceiver control module 62421. The communications control module 6242 (using its transceiver control module 62421 is responsible for handling (generating/sending/receiving) signalling between the CU 62 and other nodes or units, such as the DU 61 and other nodes and units.

The CU 62 may support the Non-Public Network (NPN), The NPN may be a Stand-alone Non-Public Network (SNPN) or a Public Network Integrated NPN (PNI-NPN).

As described above, the CU 62 can be integrated/combined with the DU 61 as an integrated/combined unit. Any functionality in the description for the CU 62 can be implemented in the integrated/combined unit above.

### <AMF>

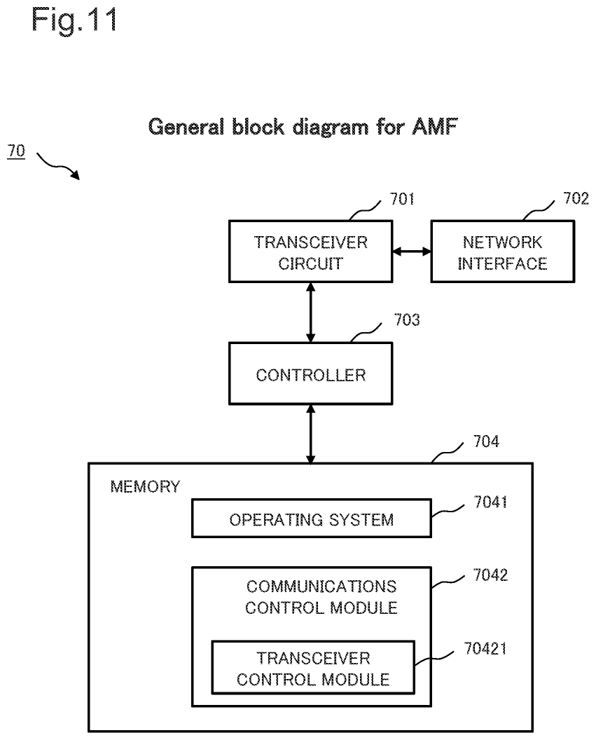

FIG. 11 is a block diagram illustrating the main components of the AMF 70. As shown, the apparatus includes a transceiver circuit 701 which is operable to transmit signals to and to receive signals from other nodes (including the UE 3) via a network interface 702. A controller 703 controls the operation of the AMF 70 in accordance with software stored in a memory 704. Software may be pre-installed in the memory 704 and/or may be downloaded via the telecommunication network or from a removable data storage device (e.g. a removable memory device (RMD)), for example. The software includes, among other things, an operating system 7041 and a communications control module 7042 having at least a transceiver control module 70421. The communications control module 7042 (using its transceiver control module 70421 is responsible for handling (generating/sending/receiving) signalling between the AMF 70 and other nodes, such as the UE 3 (e.g. via the (R)AN node 5) and other core network nodes (including core network nodes in the HPLMN of the UE 3 when the UE 3 is roaming-in. Such signalling may include, for example, appropriately formatted signalling messages (e.g. a registration request message and associated response messages) relating to access and mobility management procedures (for the UE 3).

The AMF 70 may support the Non-Public Network (NPN), The NPN may be a Stand-alone Non-Public Network (SNPN) or a Public Network Integrated NPN (PNI-NPN).

### <SMF>

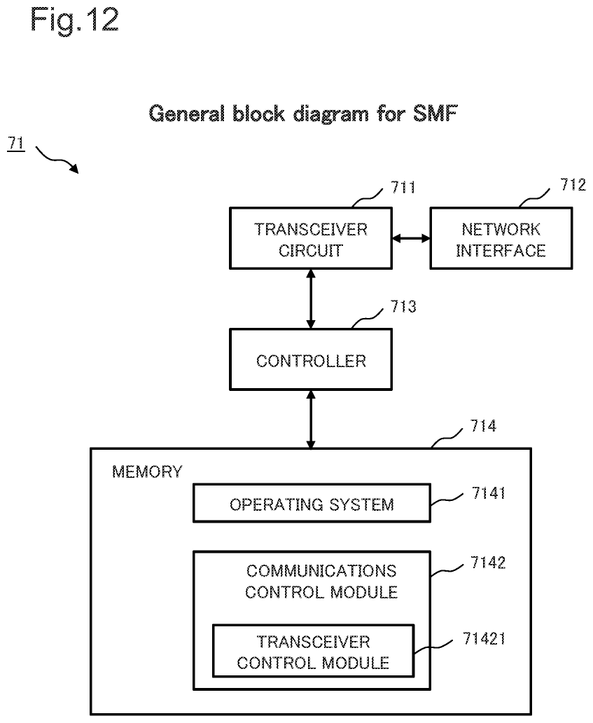

FIG. 12 is a block diagram illustrating the main components of the SMF 71. As shown, the apparatus includes a transceiver circuit 711 which is operable to transmit signals to and to receive signals from other nodes (including the AMF 70) via a network interface 712. A controller 713 controls the operation of the SMF 71 in accordance with software stored in a memory 714. Software may be pre-installed in the memory 714 and/or may be downloaded via the telecommunication network or from a removable memory device (RMD), for example. The software includes, among other things, an operating system 7141 and a communications control module 7142 having at least a transceiver control module 71421. The communications control module 7142 (using its transceiver control 71421 module is responsible for handling (generating/sending/receiving) signalling between the SMF 71 and other nodes, such as the UPF 72 and other core network nodes (including core network nodes in the HPLMN of the UE 3 when the UE 3 is roaming-in. Such signalling may include, for example, appropriately formatted signalling messages (e.g. a Hypertext Transfer Protocol (HTTP) restful methods based on the service based interfaces) relating to session management procedures (for the UE 3).

The SMF 71 may support the Non-Public Network (NPN), The NPN may be a Stand-alone Non-Public Network (SNPN) or a Public Network Integrated NPN (PNI-NPN).

Note that SMF+PGW-C may have same components to the SMF 71. In addition, the SMF+PGW-C has function of the SMF 71 and function of the PGW-C. The function of the PGW-C can be achieved by the components of the SMF+PGW-C.

### <UPF>

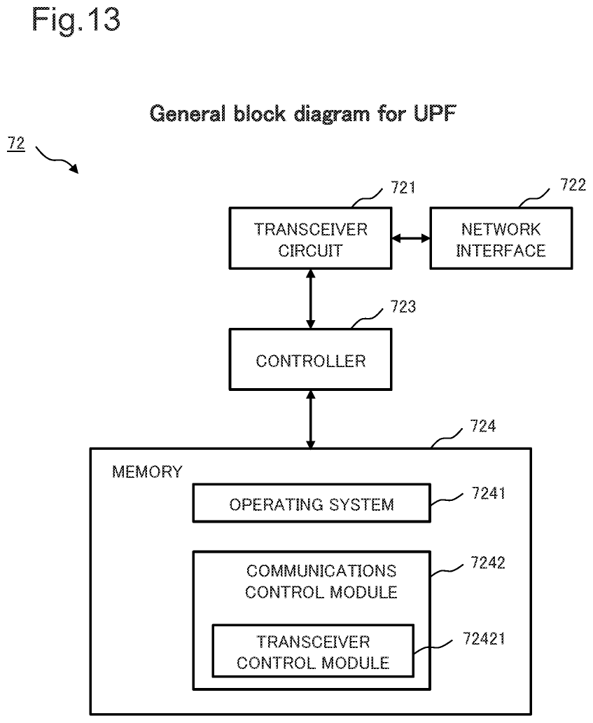

FIG. 13 is a block diagram illustrating the main components of the UPF 72. As shown, the apparatus includes a transceiver circuit 721 which is operable to transmit signals to and to receive signals from other nodes (including the SMF 71) via a network interface 722. A controller 723 controls the operation of the UPF 72 in accordance with software stored in a memory 724. Software may be pre-installed in the memory 724 and/or may be downloaded via the telecommunication network or from a removable data storage device (e.g. a removable memory device (RMD)), for example. The software includes, among other things, an operating system 7241 and a communications control module 7242 having at least a transceiver control module 72421. The communications control module 7242 (using its transceiver control module 72421 is responsible for handling (generating/sending/receiving) signalling between the UPF 72 and other nodes, such as the SMF 71 and other core network nodes (including core network nodes in the HPLMN of the UE 3 when the UE 3 is roaming-in. Such signalling may include, for example, appropriately formatted signalling messages (e.g. a GPRS Tunneling Protocol (GTP) for User plane) relating to User data handling (for the UE 3).

The UPF 72 may support the Non-Public Network (NPN), The NPN may be a Stand-alone Non-Public Network (SNPN) or a Public Network Integrated NPN (PNI-NPN).

### <PCF>

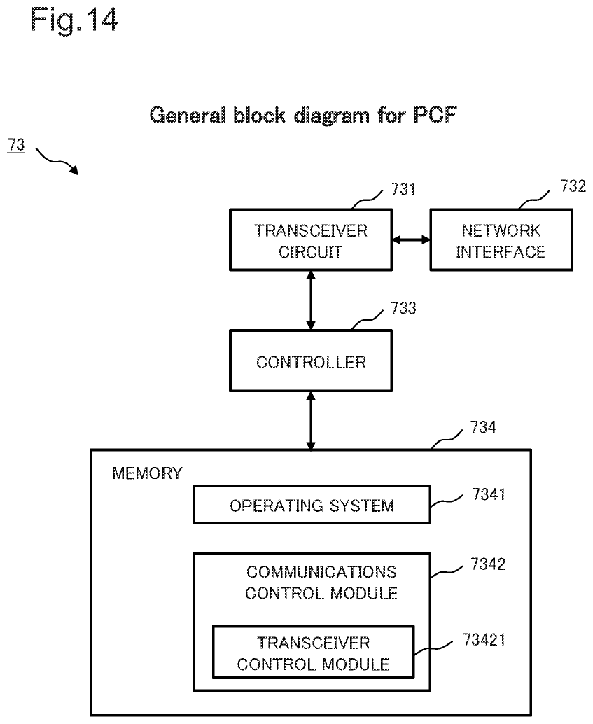

FIG. 14 is a block diagram illustrating the main components of the PCF 73. As shown, the apparatus includes a transceiver circuit 731 which is operable to transmit signals to and to receive signals from other nodes (including the AMF 70) via a network interface 732. A controller 733 controls the operation of the PCF 73 in accordance with software stored in a memory 734. Software may be pre-installed in the memory 734 and/or may be downloaded via the telecommunication network or from a removable data storage device (e.g. a removable memory device (RMD)), for example. The software includes, among other things, an operating system 7341 and a communications control module 7342 having at least a transceiver control module 73421. The communications control module 7342 (using its transceiver control module 73421 is responsible for handling (generating/sending/receiving) signalling between the PCF 73 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to policy management procedures (for the UE 3).

The PCF 73 may support the Non-Public Network (NPN), The NPN may be a Stand-alone Non-Public Network (SNPN) or a Public Network Integrated NPN (PNI-NPN).

### <NEF>

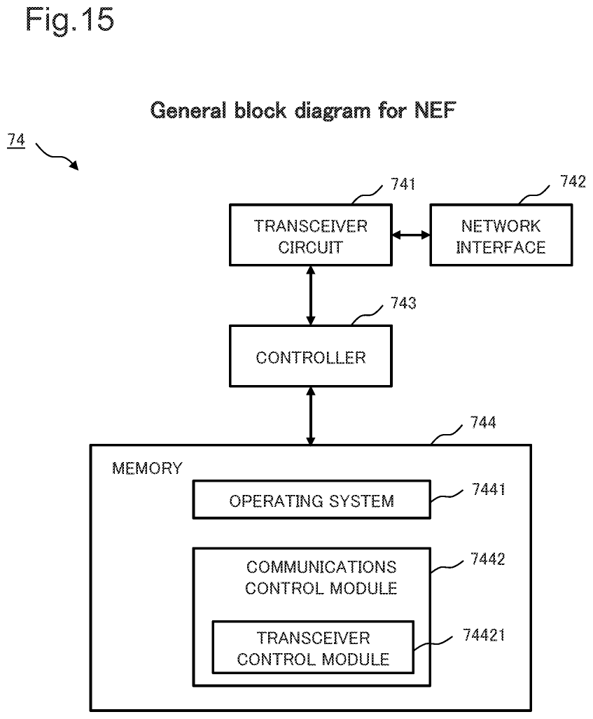

FIG. 15 is a block diagram illustrating the main components of the NEF 74. As shown, the apparatus includes a transceiver circuit 741 which is operable to transmit signals to and to receive signals from other nodes (including the UDM 75) via a network interface 742. A controller 743 controls the operation of the NEF 74 in accordance with software stored in a memory 744. Software may be pre-installed in the memory 744 and/or may be downloaded via the telecommunication network or from a removable data storage device (e.g. a removable memory device (RMD)), for example. The software includes, among other things, an operating system 7441 and a communications control module 7442 having at least a transceiver control module 74421. The communications control module 7442 (using its transceiver control module 74421 is responsible for handling (generating/sending/receiving) signalling between the NEF 74 and other nodes, such as the UDM 75 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network exposure function procedures (for the UE 3).

The NEF 74 may support the Non-Public Network (NPN), The NPN may be a Stand-alone Non-Public Network (SNPN) or a Public Network Integrated NPN (PNI-NPN).

### <UDM>

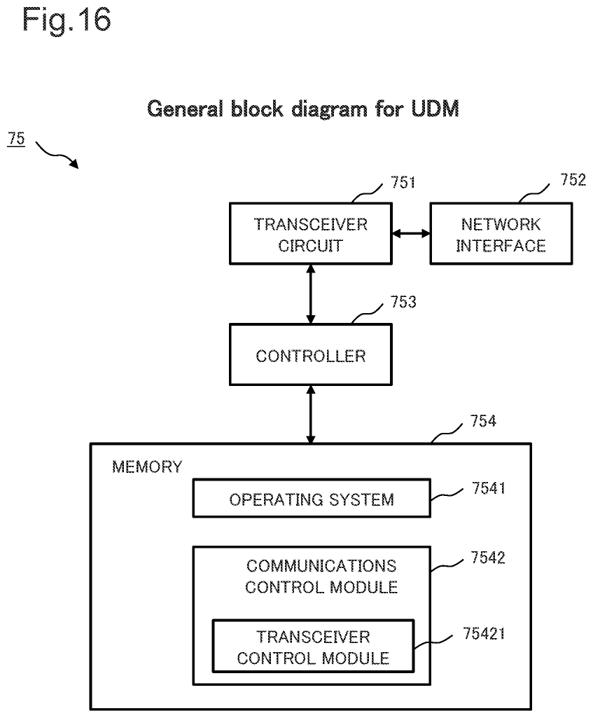

FIG. 16 is a block diagram illustrating the main components of the UDM 75. As shown, the apparatus includes a transceiver circuit 751 which is operable to transmit signals to and to receive signals from other nodes (including the AMF 70) via a network interface 752. A controller 753 controls the operation of the UDM 75 in accordance with software stored in a memory 754. Software may be pre-installed in the memory 754 and/or may be downloaded via the telecommunication network or from a removable data storage device (e.g. a removable memory device (RMD)), for example. The software includes, among other things, an operating system 7541 and a communications control module 7542 having at least a transceiver control module 75421. The communications control module 7542 (using its transceiver control module 75421 is responsible for handling (generating/sending/receiving) signalling between the UDM 75 and other nodes, such as the AMF 70 and other core network nodes (including core network nodes in the VPLMN of the UE 3 when the UE 3 is roaming-out. Such signalling may include, for example, appropriately formatted signalling messages (e.g. a HTTP restful methods based on the service based interfaces) relating to mobility management procedures (for the UE 3).

The UDM 75 may support the Non-Public Network (NPN), The NPN may be a Stand-alone Non-Public Network (SNPN) or a Public Network Integrated NPN (PNI-NPN).

### <NWDAF>

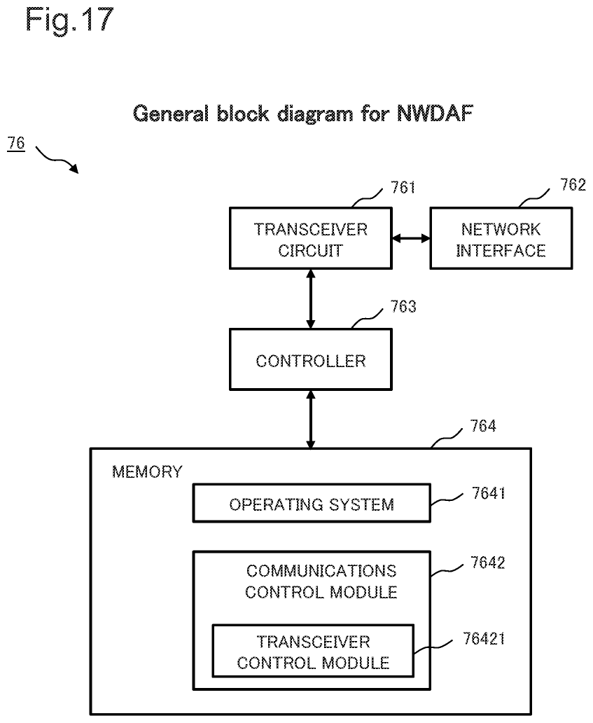

FIG. 17 is a block diagram illustrating the main components of the NWDAF 76. As shown, the apparatus includes a transceiver circuit 761 which is operable to transmit signals to and to receive signals from other nodes (including the AMF 70) via a network interface 762. A controller 763 controls the operation of the NWDAF 76 in accordance with the software stored in a memory 764. The Software may be pre-installed in the memory 764 and/or may be downloaded via the telecommunication network or from a removable data storage device (e.g. a removable memory device (RMD)), for example. The software includes, among other things, an operating system 7641 and a communications control module 7642 having at least a transceiver control module 76421. The communications control module 7642 (using its transceiver control module 76421 is responsible for handling (generating/sending/receiving) signalling between the NWDAF 76 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NWDAF 76 may support the Non-Public Network (NPN), The NPN may be a Stand-alone Non-Public Network (SNPN) or a Public Network Integrated NPN (PNI-NPN).

### <NSACF>

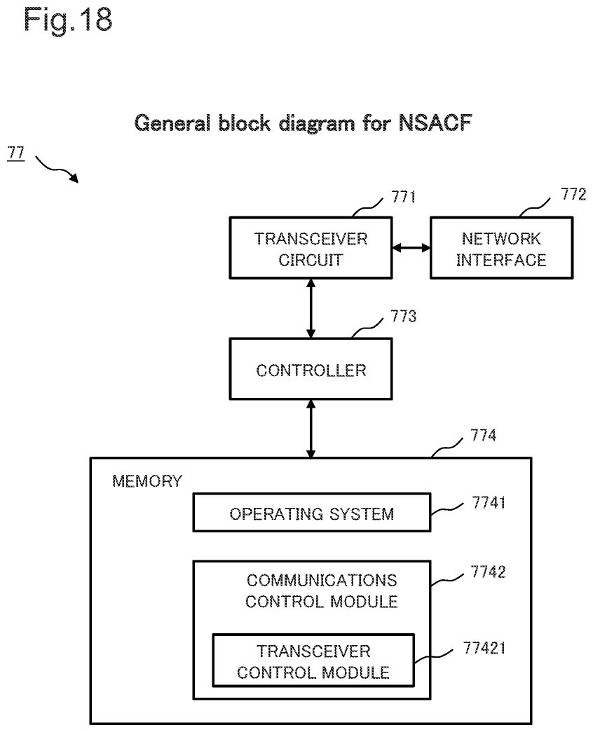

FIG. 18 is a block diagram illustrating the main components of the NSACF 77. As shown, the apparatus includes a transceiver circuit 771 which is operable to transmit signals to and to receive signals from other nodes (including the AMF 70, SMF 71 and SMF+PGW-C) via a network interface 772. A controller 773 controls the operation of the NSACF 77 in accordance with the software stored in a memory 774. The Software may be pre-installed in the memory 774 and/or may be downloaded via the telecommunication network or from a removable data storage device (RMD), for example. The software includes, among other things, an operating system 7741 and a communications control module 7742 having at least a transceiver control module 77421. The communications control module 7742 (using its transceiver control module 77421 is responsible for handling (generating/sending/receiving) signalling between the NSACF 77 and other nodes, such as the AMF 70 and other core network nodes (including core network nodes in the HPLMN of the UE 3 when the UE 3 is roaming-in. Such signalling may include, for example, appropriately formatted signalling messages (e.g. a HTTP restful methods based on the service based interfaces) relating to network data analytics function procedures (for the UE 3).

The NSACF 77 may support the Non-Public Network (NPN), The NPN may be a Stand-alone Non-Public Network (SNPN) or a Public Network Integrated NPN (PNI-NPN).

### Modifications and Alternatives

Detailed aspects have been described above. As those skilled in the art will appreciate, a number of modifications and alternatives can be made to the above aspects whilst still benefiting from the disclosures embodied therein. By way of illustration only a number of these alternatives and modifications will now be described.

In the above description, the UE 3 and the network apparatus are described for ease of understanding as having a number of discrete modules (such as the communication control modules).

Whilst these modules may be provided in this way for certain applications, for example where an existing system has been modified to implement the disclosure, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors: microprocessors; central processing units (CPUs): arithmetic logic units (ALUs); input/output (IO) circuits; internal memories/caches (program and/or data): processing registers: communication buses (e.g. control, data and/or address buses); direct memory access (DMA) functions: hardware or software implemented counters, pointers and/or timers; and/or the like.

In the above aspects, a number of software modules were described. As those skilled in the art will appreciate, the software modules may be provided in compiled or un-compiled form and may be supplied to the UE 3 and the network apparatus as a signal over a computer network, or on a recording medium. Further, the functionality performed by part or all of this software may be performed using one or more dedicated hardware circuits. However, the use of software modules is preferred as it facilitates the updating of the UE 3 and the network apparatus in order to update their functionalities.

In the above aspects, a 3GPP radio communications (radio access) technology is used. However, any other radio communications technology (e.g. WLAN, Wi-Fi, WiMAX, Bluetooth, etc.) and other fix line communications technology (e.g. BBF Access, Cable Access, optical access, etc.) may also be used in accordance with the above aspects.

Items of user equipment might include, for example, communication devices such as mobile telephones, smartphones, user equipment, personal digital assistants, laptop/tablet computers, web browsers, e-book readers and/or the like. Such mobile (or even generally stationary) devices are typically operated by a user, although it is also possible to connect so-called ‘Internet of Things’ (IoT) devices and similar machine-type communication (MTC) devices to the network. For simplicity, the present application refers to mobile devices (or UEs) in the description, but it will be appreciated that the technology described can be implemented on any communication devices (mobile and/or generally stationary) that can connect to a communications network for sending/receiving data, regardless of whether such communication devices are controlled by human input or software instructions stored in memory.

Various other modifications will be apparent to those skilled in the art and will not be described in further detail here.

The whole or part of the example Aspects disclosed above can be described as, but not limited to, the following.

### <4.11.1.5.4.1 PDN Connection Request>

The UE Requested PDN Connectivity Procedure specified in clause 5.10.2 of TS 23.401 is impacted as shown in in FIG. 4.11.1.5.4.1-1 when interworking with 5GS is supported.

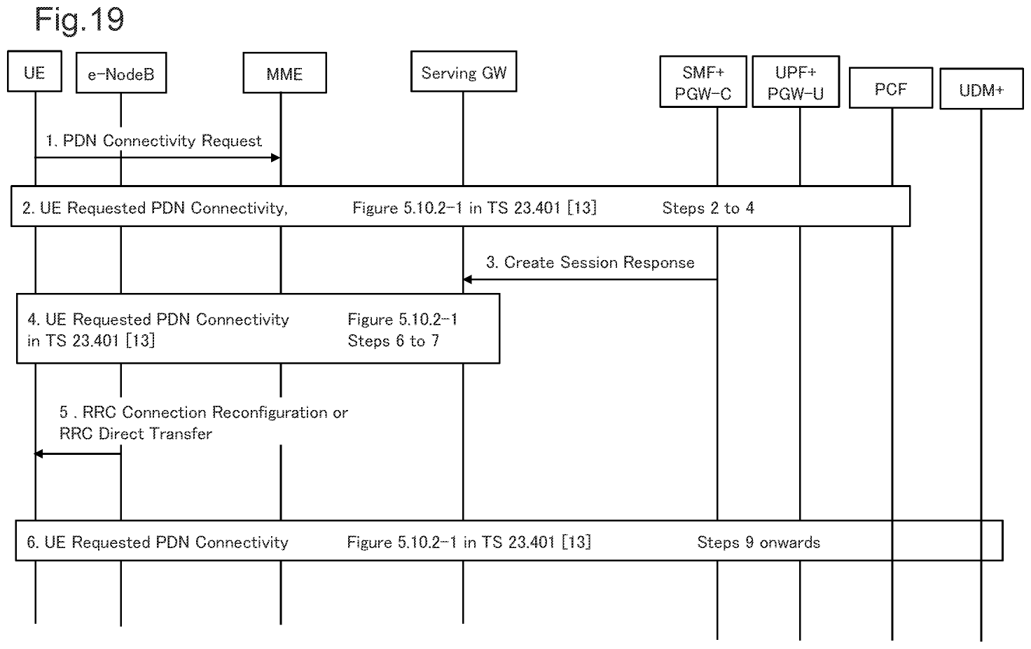

FIG. 4.11.1.5.4.1-1: Impacts to UE Requested PDN Connectivity Procedure (See FIG. 19)

1. UE sends a PDN connectivity Request to the MME as specified in Step 1 in clause 5.10.2 of TS 23.401 with the following modification:
If the UE is 5G NAS capable and the Request type is “initial request”, the UE shall allocate a PDU Session ID and include it in the PCO. The PDU Session ID shall be unique across all other PDN connections of the UE.

2. The relevant steps of the procedure as specified in the figure above are executed. In step 4 of TS 23.401 [13], IP Session Establishment/Modification procedure is replaced by SM Policy Association Establishment/Modification procedure as specified in clauses 4.16.4 and 4.16.5.

3. Step 6 as specified in clause 5.10.2 of TS 23.401 is executed with the following modification:
If the SMF+PGW-C accepts to provide interworking of the PDN connection with 5GC, the SMF+PGW-C shall allocate 5G QoS parameters corresponding to PDN connection, e.g. Session AMBR, QOS rules and QoS Flow level QoS parameters if needed for the QoS Flow(s) associated with the QoS rule(s) and then include them in PCO.
If the SMF+PGW-C accepts to provide interworking of the PDN connection with 5GC, the SMF+PGW-C shall determine the S-NSSAI associated with the PDN connection based on the operator policy, and send the S-NSSAI together with the PLMN ID to the UE in the PCO.
If the SMF+PGW-C accepts to provide interworking of the PDN connection with 5GC the SMF+PGW-C, if Small Data Rate Control is used, provides the Small Data Rate Control parameters to the UE in the PCO.

The SMF+PGW-C sends Create Session Response message containing reject cause set to PDN connection establishment failed and PCO information. The PCO information includes reject cause set to maximum number of UE reached, back off timer and the S-NSSAI or reject cause set to max number of PDU session reached, the S-NSSAI and back off timer. On receiving the Create session response, the S-GW sends create session response message to the MME containing the reject cause and PCO information. The MME sends PDN Connectivity with reject cause set to the reject cause received from the S-GW. In addition, the PDN connectivity reject message contains the PCO information element.

4. The relevant steps of the procedure as specified in the figure above are executed.

5. Step 8 as specified in clause 5.10.2 of TS 23.401 with the following modification:
If 5G QoS parameters are included in the PCO, the UE shall store them. If 5G QOS parameters are not included in the PCO, the UE shall note that session continuity for this PDN connection on mobility to 5G is not provided by the network.
If the S-NSSAI and the PLMN ID associated with the PDN connection are included in the PCO, the UE shall store them.
If the Small Data Rate Control parameters are included in the PCO, the UE shall store them.

When the UE receives PCO information, the UE starts a back off timer T1 related to the S-NSSAI when the reject cause indicates the number of UE reached the maximum threshold or timer T2 with value set to back off timer when the reject cause indicates number of PDU session reached max PDU session. The UE shall not send any PDN connectivity request message when back off timer T1 or T2 is running. When the UE moves to 5GS, the UE shall not initiate registration procedure with the S-NSSAI set to the Requested NSSAI when back off timer T1 is running and the UE shall not initiate PDU session establishment procedure for the S-NSSAI when back off timer T2 is running.

6. The relevant steps of the procedure as specified in the figure above are executed.

While the disclosure has been particularly shown and described with reference to exemplary Aspects thereof, the disclosure is not limited to these Aspects. It will be understood by those of ordinary skill in the art that various changes in form and details may be made therein without departing from the spirit and scope of the present disclosure as defined by this document. For example, the Aspects above are not limited to 5GS or EPS, and the Aspects are also applicable to communication system other than 5GS or EPS (e.g., 6G system, 5G beyond system).

The whole or part of the example Aspects disclosed above can be described as, but not limited to, the following supplementary notes.

### <First Supplementary Notes>

supplementary note 1. A method of a core network apparatus comprising:
receiving, from Serving Gateway-C(SGW-C), a Create Session Request message, wherein the Create Session Request message includes information indicating Access Point Name (APN) and information indicating that N1 mode is supported by a User Equipment (UE);
sending, to a Network Slice Admission Control Function (NSACF) apparatus, at least one of Nnsacf_NumberOfUEsPerSliceAvailabilityCheckUpdate request and Nnsacf_NumberOfPDUsPerSliceAvailabilityCheckUpdate request in a case where the Create Session Request message includes the information indicating that N1 mode is supported by the UE,
wherein the Nnsacf_NumberOfUEsPerSliceAvailabilityCheckUpdate request includes Single Network Slice Selection Assistance Information (S-NSSAI) corresponding to the APN, and
wherein the Nnsacf_NumberOfPDUsPerSliceAvailabilityCheckUpdate request includes the S-NSSAI corresponding to the APN;
receiving, from the NSACF apparatus, at least one of Nnsacf_NumberOfUEsPerSliceAvailabilityCheckUpdate response and Nnsacf_NumberOfPDUsPerSliceAvailabilityCheckUpdate response,
wherein the Nnsacf_NumberOfUEsPerSliceAvailabilityCheckUpdate response includes information indicating that registration of the UE is not allowed, and
wherein the Nnsacf_NumberOfPDUsPerSliceAvailabilityCheckUpdate response includes information indicating that establishment of Protocol Data Unit (PDU) session related to the S-NSSAI is not allowed; and
sending, to the UE via the SGW-C and Mobility Management Entity (MME), a value of a timer to suppress procedure related to the APN in a case of receiving the at least one of Nnsacf_NumberOfUEsPerSliceAvailabilityCheckUpdate response and Nnsacf_NumberOfPDUsPerSliceAvailabilityCheckUpdate response.
supplementary note 2. The method according to supplementary note 1, further comprising:
sending, to the UE, a reject cause and information indicating whether the reject cause is applicable to 5G System (5GS),
wherein the reject cause indicates that maximum number of UEs per network slice reached or maximum number of PDU sessions per network slice reached.
supplementary note 3. The method according to supplementary note 1 or 2,
wherein the Nnsacf_NumberOfUEsPerSliceAvailabilityCheckUpdate request includes information indicating the Nnsacf_NumberOfUEsPerSliceAvailabilityCheckUpdate request is sent from an Evolved Packet System (EPS), and
wherein the Nnsacf_NumberOfPDUsPerSliceAvailabilityCheckUpdate request includes information indicating the Nnsacf_NumberOfPDUsPerSliceAvailabilityCheckUpdate request is sent from the EPS.
supplementary note 4. A method of a User Equipment (UE) comprising:
performing ATTACH procedure related to Access Point Name (APN) or UE requested PDN connectivity procedure related to the APN;
receiving, from a core network apparatus, a value of a timer to suppress procedure related to the APN in a case where registration of the UE is not allowed by Network Slice Admission Control (NSAC) or establishment of Protocol Data Unit (PDU) session related to Single Network Slice Selection Assistance Information (S-NSSAI) corresponding to the APN is not allowed by the NSAC; and
retaining the procedure related to the APN while the timer runs.
supplementary note 5. The method according to supplementary note 4, further comprising:
receiving, from the core network apparatus, a reject cause and information indicating whether the reject cause is applicable to 5G System (5GS),
wherein the reject cause indicates that maximum number of UEs per network slice reached or maximum number of PDU sessions per network slice reached; and
retaining the procedure related to the S-NSSAI while the timer runs in a case where the information indicates that the reject cause is applicable to the 5GS.
supplementary note 6. A core network apparatus comprising:
means for receiving, from Serving Gateway-C(SGW-C), a Create Session Request message,
wherein the Create Session Request message includes information indicating Access Point Name (APN) and information indicating that N1 mode is supported by a User Equipment (UE);
means for sending, to a Network Slice Admission Control Function (NSACF) at apparatus, least one of Nnsacf_NumberOfUEsPerSliceAvailabilityCheckUpdate request and Nnsacf_NumberOfPDUsPerSliceAvailabilityCheckUpdate request in a case where the Create Session Request message includes the information indicating that N1 mode is supported by the UE,
wherein the Nnsacf_NumberOfUEsPerSliceAvailabilityCheckUpdate request includes Single Network Slice Selection Assistance Information (S-NSSAI) corresponding to the APN, and
wherein the Nnsacf_NumberOfPDUsPerSliceAvailabilityCheckUpdate request includes the S-NSSAI corresponding to the APN;
means for receiving, from the NSACF apparatus, at least one of Nnsacf_NumberOfUEsPerSliceAvailabilityCheckUpdate response and Nnsacf_NumberOfPDUsPerSliceAvailabilityCheckUpdate response,
wherein the Nnsacf_NumberOfUEsPerSliceAvailabilityCheckUpdate response includes information indicating that registration of the UE is not allowed, and
wherein the Nnsacf_NumberOfPDUsPerSliceAvailabilityCheckUpdate response includes information indicating that establishment of Protocol Data Unit (PDU) session related to the S-NSSAI is not allowed; and
means for sending, to the UE via the SGW-C and Mobility Management Entity (MME), a value of a timer to suppress procedure related to the APN in a case of receiving the at least one of Nnsacf_NumberOfUEsPerSliceAvailabilityCheckUpdate response and Nnsacf_NumberOfPDUsPerSliceAvailabilityCheckUpdate response.
supplementary note 7. The core network apparatus according to supplementary note 6, further comprising:
means for sending, to the UE, a reject cause and information indicating whether the reject cause is applicable to 5G System (5GS),
wherein the reject cause indicates that maximum number of UEs per network slice reached or maximum number of PDU sessions per network slice reached.
supplementary note 8. The core network apparatus according to supplementary note 6 or 7,
wherein the request Nnsacf_NumberOfUEsPerSliceAvailabilityCheckUpdate includes information indicating the Nnsacf_NumberOfUEsPerSliceAvailabilityCheckUpdate request is sent from a Evolved Packet System (EPS), and
wherein the Nnsacf_NumberOfPDUsPerSliceAvailabilityCheckUpdate request includes information indicating the Nnsacf_NumberOfPDUsPerSliceAvailabilityCheckUpdate request is sent from the EPS.
supplementary note 9. A User Equipment (UE) comprising:
means for performing ATTACH procedure related to Access Point Name (APN) or UE requested PDN connectivity procedure related to the APN;
means for receiving, from a core network apparatus, a value of a timer to suppress procedure related to the APN in a case where registration of the UE is not allowed by Network Slice Admission Control (NSAC) or establishment of Protocol Data Unit (PDU) session related to Single Network Slice Selection Assistance Information (S-NSSAI) corresponding to the APN is not allowed by the NSAC; and
means for retaining the procedure related to the APN while the timer runs.
supplementary note 10. The UE according to supplementary note 9, further comprising:
means for receiving, from the core network apparatus, a reject cause and information indicating whether the reject cause is applicable to 5G System (5GS),
wherein the reject cause indicates that maximum number of UEs per network slice reached or maximum number of PDU sessions per network slice reached; and
means for retaining the procedure related to the S-NSSAI while the timer runs in a case where the information indicates that the reject cause is applicable to the 5GS.
supplementary note 11. A method of a User Equipment (UE) comprising:
receiving a value of a timer to suppress procedure related to Single Network Slice Selection Assistance Information (S-NSSAI) in a case where registration of the UE is not allowed by Network Slice Admission Control (NSAC) or establishment of Protocol Data Unit (PDU) session related to the S-NSSAI is not allowed by the NSAC;
starting the timer;
moving from 5G System (5GS) to Evolved Packet System (EPS) while the timer runs;
retaining procedure related to Access Point Name (APN) corresponding to the S-NSSAI in a case where the timer runs; and
performing the procedure related to the APN corresponding to the S-NSSAI in a case where the timer expires.
supplementary note 12. The method according to supplementary note 11, further comprising:
receiving information indicating whether the timer is applicable to the EPS; and
retaining the procedure related to the APN while the timer runs in a case where the information indicates that the timer is applicable to the EPS.
supplementary note 13. A User Equipment (UE) comprising:
means for receiving a value of a timer to suppress procedure related to Single Network Slice Selection Assistance Information (S-NSSAI) in a case where registration of the UE is not allowed by Network Slice Admission Control (NSAC) or establishment of Protocol Data Unit (PDU) session related to the S-NSSAI is not allowed by the NSAC;
means for starting the timer;
means for moving from 5G System (5GS) to Evolved Packet System (EPS) while the timer runs;
means for retaining procedure related to Access Point Name (APN) corresponding to the S-NSSAI in a case where the timer runs; and
means for performing the procedure related to the APN corresponding to the S-NSSAI in a case where the timer expires.
supplementary note 14. The UE according to supplementary note 13, further comprising:
means for receiving information indicating whether the timer is applicable to the EPS; and
means for retaining the procedure related to the APN while the timer runs in a case where the information indicates that the timer is applicable to the EPS.
supplementary note 15. A method of a communication apparatus comprising:
receiving, from a first communication apparatus, information indicating a timer; and
applying the timer if the communication apparatus moves from a first network system to a second network system within same mobile network.
supplementary note 16. The method according to Supplementary note 15,
wherein the timer is a timer for the communication apparatus.
supplementary note 17. The method according to Supplementary note 15 or Supplementary note 16,
wherein the communication apparatus initiates a registration procedure related to network slice if the timer expires.
supplementary note 18. The method according to Supplementary note15,
wherein the timer is a timer for a PDU (Protocol Data Unit) session.
supplementary note 19. The method according to Supplementary note 18,
wherein the communication apparatus does not initiate a PDU session establishment procedure if the timer for the PDU session is still running.
supplementary note 20. The method according to Supplementary note 18 or Supplementary note 19,
wherein the communication apparatus initiates the PDU session establishment procedure if the timer for the PDU session is expires.
supplementary note 21. A method of a communication apparatus comprising:
receiving, from a first communication apparatus, information indicating a timer; and
clearing the timer if the communication apparatus moves from a first network system in a first mobile network to a second network system in a second mobile network which is different from the first mobile network.
supplementary note 22. A method of a first core network apparatus comprising:
receiving, from a second core network apparatus, first information indicating that a communication apparatus can be registered to a second network system which is different from a first network system;
sending, to a third core network apparatus, second information to check availability of the communication apparatus related to a network slice;
receiving, from the third core network apparatus, third information response to the second information; and
sending, to the second core network apparatus, forth information including reject cause information indicating cause of Packet Data Network (PDN) session error, timer for Protocol Data Unit (PDU) session or information related to the network slice after receiving the second information.
supplementary note 23. A method of a first core network apparatus comprising:
receiving, from a second core network apparatus, first information indicating that a communication apparatus can be registered to a second network system (5GS) which is different from a first network system;
sending, to a third core network apparatus, fifth information to check availability of the Protocol Data Unit (PDU) session related to a network slice;
receiving, from a third core network apparatus, sixth information response to the fifth information; and
sending, to the second core network apparatus, seventh information including reject cause information indicating cause of Packet Data Network (PDN) session error, timer for Protocol Data Unit (PDU) session or information related to the network slice after receiving the fifth information.
supplementary note 24. A method of a communication apparatus comprising:
communicating with a core network apparatus; and
applying a timer for the communication apparatus.
supplementary note 25. The method according to Supplementary note 24,
wherein the communication apparatus initiates an attach procedure if the timer for the communication apparatus expires.
supplementary note 26. The method according to Supplementary note 24,
wherein the communication apparatus initiates a Tracking Area Update (TAU) procedure if the timer for the communication apparatus expires.
supplementary note 27. The method according to Supplementary note 24,
wherein the communication apparatus initiates the communication apparatus requested Packet Data Network (PDN) connectivity procedure if the timer for the communication apparatus expires.
supplementary note 28. A method of a communication apparatus comprising:
communicating with a core network apparatus; and
applying a timer for Protocol Data Unit (PDU) session.
supplementary note 29. The method according to Supplementary note 28,
wherein the communication apparatus initiates an attach procedure if the timer for the communication apparatus expires.
supplementary note 30. The method according to Supplementary note 28,
wherein the communication apparatus initiates a Tracking Area Update (TAU) procedure if the timer for the communication apparatus expires.
supplementary note 31. The method according to Supplementary note 28,
wherein the communication apparatus initiates the communication apparatus requested Packet Data Network (PDN) procedure if the timer for the communication apparatus expires.
supplementary note 32. A method of a communication apparatus comprising:
communicating with a core network apparatus; and
applying a timer for the communication apparatus and a timer for Protocol Data Unit (PDU) session.
supplementary note 33. The method according to Supplementary note 32,
wherein the communication apparatus initiates an attach procedure if the timer for the communication apparatus and the timer for Protocol Data Unit (PDU) session expires.
supplementary note 34. The method according to Supplementary note 32,
wherein the communication apparatus initiates a Tracking Area Update (TAU) procedure if the timer for the communication apparatus and the timer for Protocol Data Unit (PDU) session expires.
supplementary note 35. The method according to Supplementary note 32,
wherein the communication apparatus initiates the communication apparatus requested a Packet Data Network (PDN) procedure if the timer for the communication apparatus and the timer for Protocol Data Unit (PDU) session expires.

### <Second Supplementary Notes>

supplementary note 1. A method performed by a radio terminal comprising:
receiving, from a core network, a reject message related to a first access type with information including maximum number of Protocol Data Unit (PDU) Session per network slice reached; and
requesting a PDU session via a second access type.
supplementary note 2. The method according to supplementary note 1, wherein the information includes at least one of a Back off timer (BOT) and the first access type.
supplementary note 3. The method according to supplementary note 2, wherein the PDU session via the second access type is requested while the BOT is running.
supplementary note 4. A radio terminal comprising:
means for receiving, from a core network, a reject message related to a first access type with information including maximum number of Protocol Data Unit (PDU) Session per network slice reached; and
means for requesting a PDU session via a second access type.
supplementary note 5. The radio terminal according to supplementary note 4, wherein the information includes at least one of a Back off timer (BOT) and the first access type.
supplementary note 6. The radio terminal according to supplementary note 5, wherein the means for requesting requests the PDU session via the second access type while the BOT is running.

While the invention has been particularly shown and described with reference to example embodiments thereof, the invention is not limited to these embodiments. It will be understood by those of ordinary skill in the art that various changes in form and details may be made therein without departing from the spirit and scope of the present invention as defined by the claims.

This application is based upon and claims the benefit of priority from Indian provisional patent application No. 202111032116, filed on Jul. 16, 2021, the disclosure of which is incorporated herein in its entirety by reference.

### REFERENCE SIGNS LIST

1 telecommunication system
3 UE
5 (R)AN node
7 core network
20 data network
31 transceiver circuit
32 antenna
33 controller
34 user interface
35 USIM
36 memory
51 transceiver circuit
52 antenna
53 network interface
54 controller
55 memory
60 RU
61 DU
62 CU
70 AMF
71 SMF
72 UPF
73 PCF
74 NEF
75 UDM
76 NWDAF
77 NSACF
361 operating system
362 communications control module
551 operating system
552 communications control module
601 transceiver circuit
602 antenna
603 network interface
604 controller
605 memory
611 transceiver circuit
612 network interface
613 controller
614 memory
621 transceiver circuit
622 network interface
623 controller
624 memory
701 transceiver circuit
702 network interface
703 controller
704 memory
711 transceiver circuit
712 network interface
713 controller
714 memory
721 transceiver circuit
722 network interface
723 controller
724 memory
731 transceiver circuit
732 network interface
733 controller
734 memory
741 transceiver circuit
742 network interface
743 controller
744 memory
751 transceiver circuit
752 network interface
753 controller
754 memory
761 transceiver circuit
762 network interface
763 controller
764 memory
771 transceiver circuit
772 network interface
773 controller
774 memory
3621 transceiver control module
5521 transceiver control module
6051 operating system
6052 communications control module
6141 operating system
6142 communications control module
6241 operating system
6242 communications control module
7041 operating system
7042 communications control module
7141 operating system
7142 communications control module
7241 operating system
7242 communications control module
7341 operating system
7342 communications control module
7441 operating system
7442 communications control module
7541 operating system
7542 communications control module
7641 operating system
7642 communications control module
7741 operating system
7742 communications control module
60521 transceiver control module
61421 transceiver control module
62421 transceiver control module
70421 transceiver control module
71421 transceiver control module
72421 transceiver control module
73421 transceiver control module
74421 transceiver control module
75421 transceiver control module
76421 transceiver control module
77421 transceiver control module

What is claimed is:

1. A method performed by a radio terminal comprising:
receiving, from a core network, a reject message related to a first access type with information including maximum number of Protocol Data Unit (PDU) Session per network slice reached; and
requesting a PDU Session via a second access type.

2. The method according to claim 1, wherein the information includes at least one of a Back off timer (BOT) and the first access type.

3. The method according to claim 2, wherein the PDU Session via the second access type is requested while the BOT is running.

4. A radio terminal comprising:
a memory; and
at least one processor configured to access the memory and configured to:
receiving, from a core network, a reject message related to a first access type with information including maximum number of Protocol Data Unit (PDU) Session per network slice reached; and
requesting a PDU Session via a second access type.

5. The radio terminal according to claim 4, wherein the information includes at least one of a Back off timer (BOT) and the first access type.

6. The radio terminal according to claim 5, wherein
the at least one processor is configured to access the memory and configured to:
requesting requests the PDU Session via the second access type while the BOT is running.
